(19) United States
(12) Patent Application Publication
(10) Pub. No.: US 2016/0227532 A1
(43) Pub. Date: Aug. 4, 2016

(54) SYSTEMS, METHODS, AND DEVICES FOR SIGNAL CLASSIFICATION IN WIRELESS NETWORKS

(71) Applicants: Shahrnaz Azizi, Cupertino, CA (US); Thomas Kenney, Portland, OR (US); Minyoung Park, Portland, OR (US); Eldad Perahia, Portland, OR (US); Robert Stacey, Portland, OR (US)

(72) Inventors: Shahrnaz Azizi, Cupertino, CA (US); Thomas Kenney, Portland, OR (US); Minyoung Park, Portland, OR (US); Eldad Perahia, Portland, OR (US); Robert Stacey, Portland, OR (US)

(21) Appl. No.: 14/752,335

(22) Filed: Jun. 26, 2015

Related U.S. Application Data
(60) Provisional application No. 62/110,965, filed on Feb. 2, 2015.

(51) Int. Cl. H04W 72/04; H04L 29/06

(52) U.S. Cl. CPC H04W 72/0446; H04L 69/22

(57) ABSTRACT

Embodiments of the disclosure relate to systems, methods, and devices for classification of signals in wireless networks. The method includes generating, by a communication device, one or more symbols comprising differentially orthogonal long training sequences, inserting the one or more symbols in one or more frames comprising a plurality of orthogonal frequency-division multiple access symbols and a payload field, and transmitting the one or more frames to a wireless device. The payload may be modulated according to an on-off keying modulation scheme or may be encoded according to a multi-repetition encoding scheme.

### CROSS-REFERENCE TO RELATED APPLICATIONS

This U.S. non-provisional patent application claims priority of U.S. provisional application No. 62/110,965 titled “SYSTEMS, METHODS, AND DEVICES FOR SIGNAL CLASSIFICATION IN WIRELESS NETWORKS” which was filed on Feb. 2, 2015, the entire contents of which is incorporated herein by reference.

### TECHNICAL FIELD

Embodiments described herein generally relate to wireless networks. More specifically to systems, methods, and devices for signal classification in wireless communication networks.

### BACKGROUND

In certain telecommunication systems an access point (or base station) may provide wireless transmissions to a communication station (STA) or other type of user equipment in the downstream link (or downlink) at a power that is higher than the transmit power utilized by the communication station or device to send a wireless transmission in the upstream link (or uplink) to the access point. Such asymmetry in the transmit power in the downlink and uplink may be enabled by scheduling and allocating a narrow resource block to the STA that is associated or otherwise attached to the AP.

A next generation WLAN, IEEE 802.11ax or High-Efficiency WLAN (HEW), is under development. Uplink multiuser MIMO (UL MU-MIMO) and Orthogonal Frequency-Division Multiple Access (OFDMA) are two features included in the standard.

### BRIEF DESCRIPTION OF THE DRAWINGS

The accompanying drawings form an integral part of the disclosure and are incorporated into the present specification. The drawings illustrate example embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure may be implemented in many different forms and should not be construed as limited to the implementations set forth herein. Like numbers refer to like elements throughout.

FIG. 1 is a network diagram illustrating an example network environment, according to one or more example embodiments of the disclosure;

FIG. 2 illustrates resource allocation in a physical layer OFDM frame, according to one or more example embodiments of the disclosure;

FIG. 3 illustrates preamble structure in a physical layer OFDM frame, according to one or more example embodiments of the disclosure;

FIG. 4 illustrates an example packet format using on-off keying (OOK) for narrow-band resource allocation request frame, according to one or more example embodiments of the disclosure;

FIG. 5 illustrates an example packet format using eight times repetition coding for narrow-band resource allocation request frame, according to one or more example embodiments of the disclosure;

FIG. 6 illustrates use of additional OFDM symbols for 11ax classification, according to one or more example embodiments of the disclosure;

FIG. 7 presents an example of a communication device in accordance with one or more embodiments of the disclosure;

FIG. 8 presents an example of a radio unit in accordance with one or more embodiments of the disclosure;

FIG. 9 presents another example of a communication device in accordance with one or more embodiments of the disclosure;

FIG. 10 presents another example of a radio unit in accordance with one or more embodiments of the disclosure;

FIG. 11 presents an example of a computational environment in accordance with one or more embodiments of the disclosure;

FIG. 12 presents another example of a communication device in accordance with one or more embodiments of the disclosure; and

FIGS. 13-14 present example methods in accordance with one or more embodiments of the disclosure.

### DETAILED DESCRIPTION

Example embodiments described herein provide certain systems, methods, and devices, for providing signaling information to Wi-Fi devices in various Wi-Fi networks, including, but not limited to, IEEE 802.11ax.

According to one or more example embodiments, new packet formats that may use OOK (On-Off Keying) and eight times repetition coding (Rep8) may be used in an IEEE 802.11ax network to resolve a possible link-budget imbalance problem. According to one or more example embodiments, a packet classification method may be used to distinguish between an 802.11ax packet and an OOK or a Rep8 802.11ax packet formats. According to one or more example embodiments, a packet classification method may be used to distinguish between an 802.11ax packet and a legacy 11a/g/n/ac packet. The disclosure recognizes and addresses, in at least certain embodiments, the issue of association between communication devices in the presence of a link-budget imbalance between such devices. More specifically, yet not exclusively, the disclosure provides devices, systems, techniques, and/or computer program products that may permit association between a station or other type of user equipment and an AP in the presence of a link-budget imbalance between the uplink and the downlink of the station, for example. At least certain embodiments of the disclosure may be applied to any unscheduled uplink packet transmissions initiated by a station when such a link-budget imbalance is present.

The embodiments of certain systems, methods, and devices described in the present disclosure may provide techniques for signaling information to Wi-Fi devices in various Wi-Fi networks. The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Details of one or more implementations are set forth in the accompanying drawings and in the description below. Further embodiments, features, and aspects will become apparent from the description, the drawings, and the claims. Embodiments set forth in the claims encompass all available equivalents of those claims.

The terms “communication station”, “station”, “handheld device”, “mobile device”, “wireless device” and “user equipment” (UE), as used herein, refer to a wireless communication device such as a cellular telephone, smartphone, tablet, netbook, wireless terminal, laptop computer, a wearable computer device, a picocell, a femtocell, High Data Rate (HDR) subscriber station, access point, access terminal, or other personal communication system (PCS) device. The device may be either mobile or stationary.

The term “access point” (AP) as used herein may be a fixed station. An access point may also be referred to as an access node, a base station or some other similar terminology known in the art. An access terminal may also be called a mobile station, a user equipment (UE), a wireless communication device or some other similar terminology known in the art. Embodiments disclosed herein generally pertain to wireless networks. Some embodiments may relate to wireless networks that operate in accordance with one of the IEEE 802.11 standards including the IEEE 802.11ax standard.

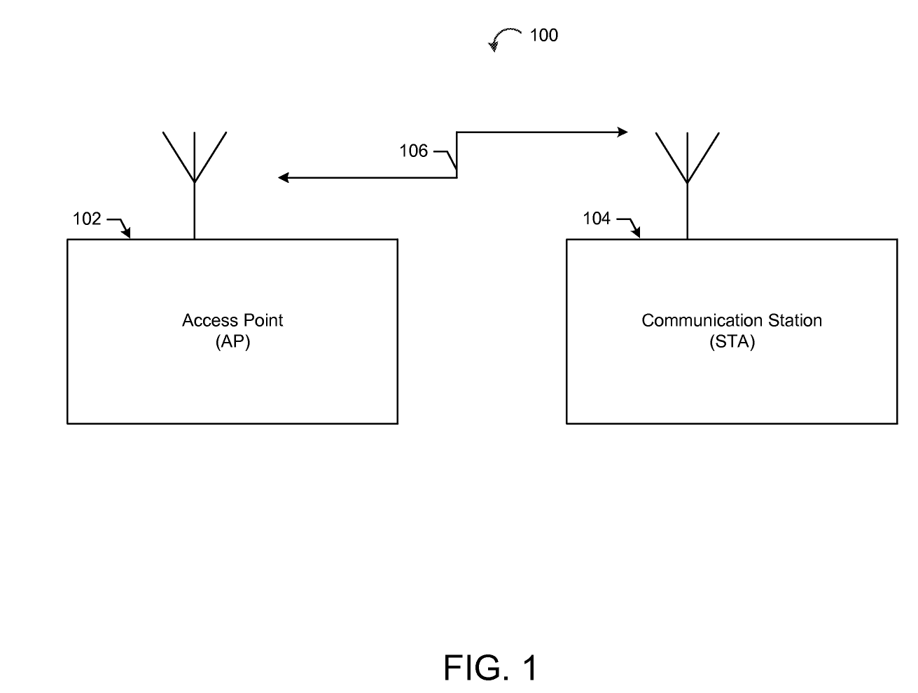

FIG. 1 is a network diagram illustrating an example network environment, according to some example embodiments of the present disclosure. Wireless network 100 may include one or more communication stations (STAs) 104 and one or more access points (APs) 102, which may communicate in accordance with IEEE 802.11 communication standards, including IEEE 802.11ax. The communication stations 104 may be mobile devices that are non-stationary and do not have fixed locations. The one or more APs may be stationary and have fixed locations. The stations may include an AP communication station (AP) 102 and one or more responding communication stations STAs 104.

In accordance with some IEEE 802.11ax (High-Efficiency WLAN (HEW)) embodiments, an access point may operate as a master station which may be arranged to contend for a wireless medium (e.g., during a contention period) to receive exclusive control of the medium for an HEW control period (i.e., a transmission opportunity (TXOP)). The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique.

The master station may also communicate with legacy stations in accordance with legacy IEEE 802.11 communication techniques. In some embodiments, the master station may also be configurable communicate with HEW stations outside the HEW control period in accordance with legacy IEEE 802.11 communication techniques, although this is not a requirement.

In other embodiments, the links of an HEW frame may be configurable to have the same bandwidth and the bandwidth may be one of 20 MHz, 40 MHz, or 80 MHz contiguous bandwidths or an 80+80 MHz (160 MHz) non-contiguous bandwidth. In certain embodiments, a 320 MHz contiguous bandwidth may be used. In other embodiments, bandwidths of 5 MHz and/or 10 MHz may also be used. In these embodiments, each link of an HEW frame may be configured for transmitting a number of spatial streams.

As described in greater detail below, the computing devices, systems, platforms, methods, and computer program products disclosed herein may address a link-budget imbalance between the uplink (UL) and the downlink (DL) and may close the UL by leveraging or otherwise utilizing robust modulation and/or encoding. More specifically, in the pre-association stage, a station or other type of user equipment may rely on on-off keying (OOK), amplitude shift keying (ASK), frequency shift keying (FSK), or a repetition coding scheme at a lower rate than the rate utilized in a post-association stage. As such, the STA may send a request, to an AP, to be scheduled for a narrow bandwidth (e.g., δ) transmission in a UL channel having a bandwidth Δ. Here, δ and Δ are real numbers and, in one aspect, δ<<Δ. In certain embodiments, δ=2.5 MHz and Δ=20 MHz. In response to receiving the request for the resource allocation, the AP may schedule the STA station for an uplink transmission with the narrow bandwidth δ (e.g., 2.5 MHz) in the Δ (e.g., 20 MHz) channel bandwidth. As such, the AP may send resource allocation information to the STA conveying the allocated narrow bandwidth resource block. In response to receiving the allocation information, the STA may send an association request frame suitable for the narrow bandwidth δ at a scheduled time, for example, using the allocated narrowband resource block in the Δ channel bandwidth.

It should be appreciated that such a narrow frequency allocation, as achieved via at least certain embodiments of the disclosure, may be useful for services or other type of applications, such as the Internet-of-things (IOT) that may need to support many stations with low data traffic. In addition, at least certain embodiments of the disclosure may permit reducing power consumption at a station or other type of user equipment and, thus, lowering manufacturing costs of the station or the other type of user equipment. Power consumption may be reduced by configuring the station or the other type of user equipment to transmit at lower power in a suitable narrowband resource block.

For example, within a Δ=20 MHz channel bandwidth, an AP may allocate multiple smaller frequency channel allocations for different communication device (e.g., stations or other type of user equipment). The minimum resource allocation size may be, for example, as small as 2.5 MHz for a single communication device. In such a scenario, at most eight STAs may access the physical medium (e.g., the air interface) simultaneously or nearly simultaneously in a 20 MHz channel for uplink data transmissions to their associated AP. In addition, since each of the STAs may utilize a channel bandwidth that is about eight times narrower than the 20 MHz downlink channel, an STA's uplink may have about 9 dB higher link budget than the downlink when the STA utilizes the same transmit power as in transmission in the 2.5 MHz channel. In other words, the station may use 9 dB lower transmit power for low power consumption and low cost while having the same link budget in both uplink and downlink.

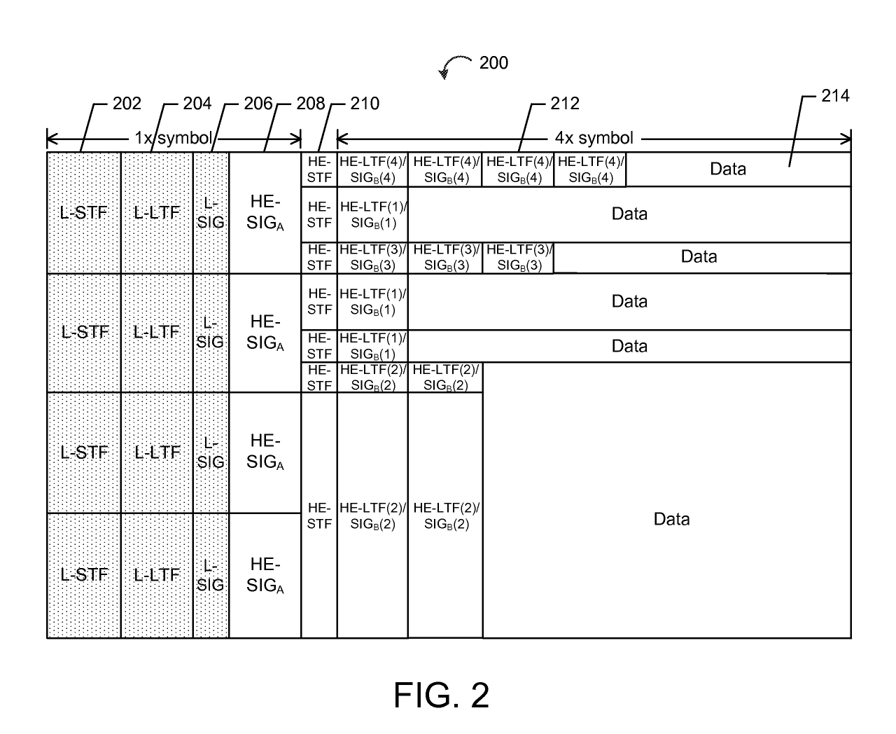

In some example embodiments, the physical layer header is designed to not only reduce the overhead but also increase the reliability of the signal field (SIG). A good design would. The indication of the resource allocation is a responsibility of SIG, providing information about the physical signal format for the user to decode and find his/her data. The resources are distributed in frequency and time as illustrated in FIG. 2, for example. The example physical layer frame format of an OFDM signal 200 illustrated in FIG. 2 may include a legacy portion and an 802.11ax portion, for example. The legacy portion may include legacy short training field (L-STF) 202, legacy long training field (L-LTF) 204, and a legacy signal field (L-SIG) 206, for example. The 802.11ax portion may include a high-efficiency signal field (HE-SIGA) 208, a high-efficiency short training field (HE-STF) 210, a high-efficiency long training field (HE-LTF) 212, and a data field 214, for example. The 802.11ax portion may include both broadcast and beamformed parts. HE-SIGA may be the broadcast and the rest, for example, HE-STF, HE-LTF and DATA may be sent with or without beamforming or with or without power boosting, for example. The HE-STF may be used to reset the automatic gain control (AGC) and the HE-LTF may be used to retrain the channel, for example. As illustrated in FIG. 2, the SIG usually uses 20-50 bits per user. Example methods and system disclosed herein provide an efficient approach to provide signaling using preamble structures. Compared with the existing designs in DensiFi, the disclosed systems, methods, and devices have lower overheads due to use of lower bits in the frame structure.

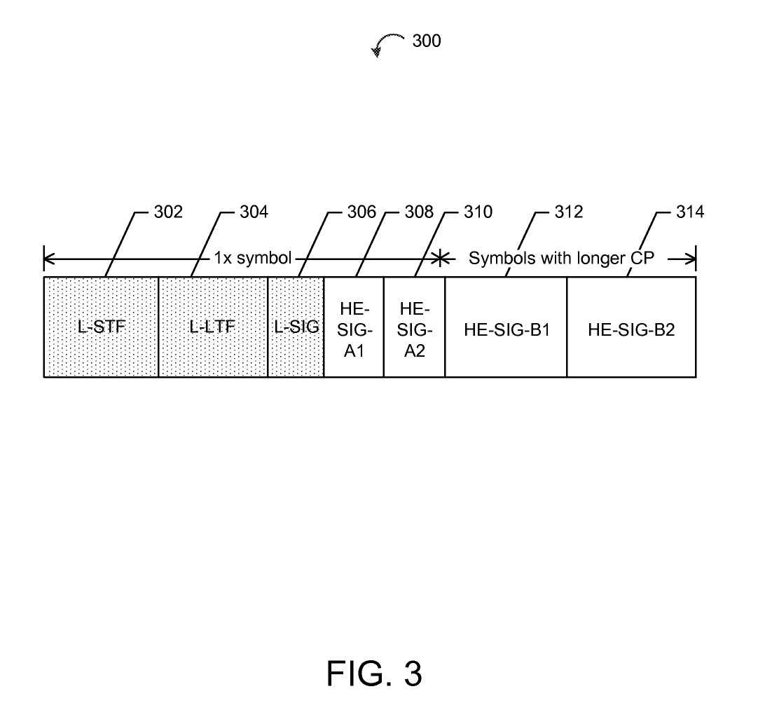

Turning now to FIG. 3, illustrated is a preamble structure 300 for a mixed mode, where legacy and IEEE 802.11ax devices may coexist, according to one or more example embodiments of the present disclosure. In FIG. 3, L-STF may denote a legacy short training field 302, L-LTF may denote a legacy long training field 304, L-SIG may denote a legacy SIGNAL field 306, HE-SIG-A1 (or HE-SIG-0-1) may denote a high efficiency SIGNAL field A (or 0) symbol 1 308, HE-SIG-A2 (or HE-SIG-0-2) may denote a high efficiency SIGNAL field A (or 0) symbol 2 310, HE-SIG-B1 (or HE-SIG-1-1) may denote a high efficiency SIGNAL field B (or 1) symbol 1 312, HE-SIG-B2 (or HE-SIG-1-2) may denote a high efficiency SIGNAL field B (or 1) symbol 2 314, for example.

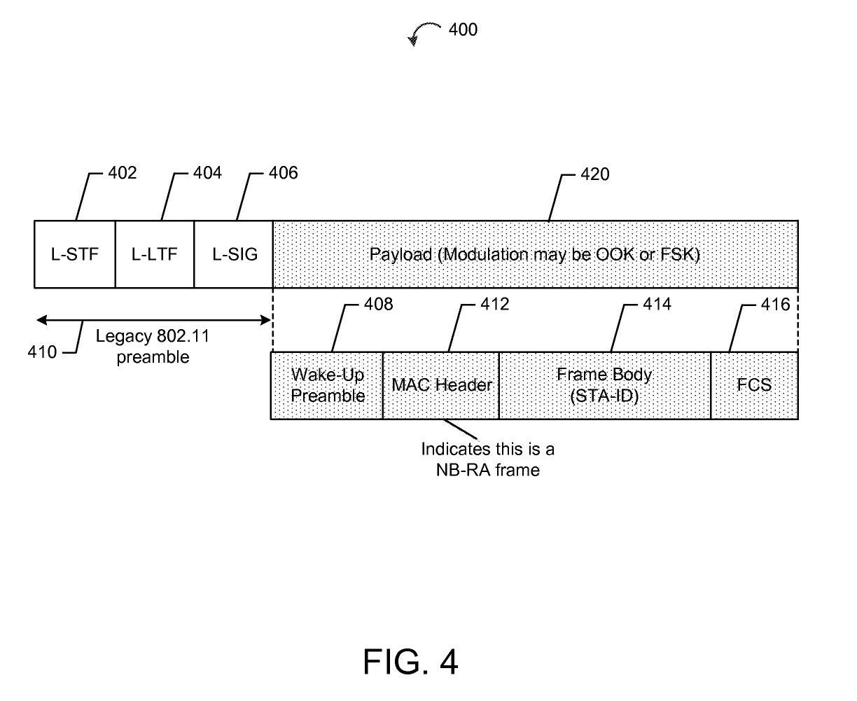

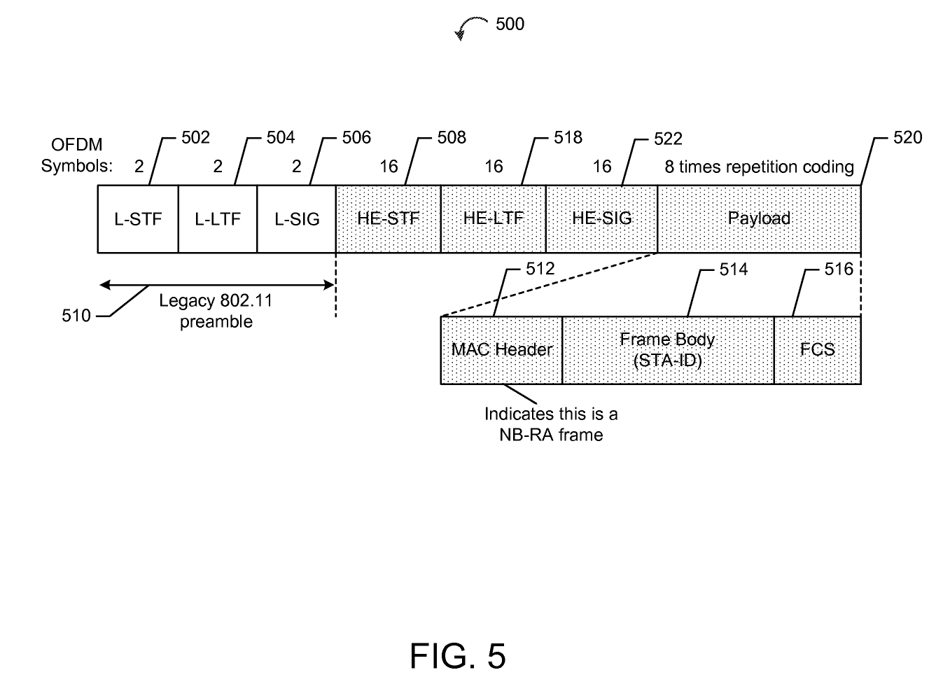

According to one or more example embodiments, example packet formats that use OOK (On-Off Keying) 400, as illustrated in FIG. 4, and eight times repetition coding (Rep8) 500, as illustrated in FIG. 5, for example, may be used in a IEEE 802.11ax network to resolve a possible link-budget imbalance problem that may arise in the packet configurations illustrated in FIGS. 2 and 3. According to one or more example embodiments, a packet classification method 600 may be used to distinguish between an 802.11ax packet and a OOK as illustrated in FIG. 4 or a Rep8 802.11ax packet as illustrated in FIG. 5 or even a legacy 11a/g/n/ac packet.

FIG. 4 illustrates an example of a narrow band resource allocation (NB-RA) request frame 400 in accordance with one or more embodiments of the disclosure. As illustrated, the NB-RA request frame 400 may include a legacy preamble 410 that may be decoded and/or otherwise processed by a STA operating according to a contemporaneous radio protocol (e.g., IEEE 802.ax) utilized by an AP to which the STA attempts to associate with, or to a legacy radio protocol (e.g., IEEE 802.11a, IEEE 802.e, or IEEE 802.n). As such, the legacy preamble 410 is included for third-party legacy STAs to provide information such as the length of the packet for coexistence. In one example, the legacy preamble 410 may be formatted according to IEEE 802.11 protocols. The legacy preamble 410 also may be processed (e.g., decoded) by non-legacy communication devices. The NB-RA request frame 400 also may include a payload portion 420 (referred to as payload 420) that may include one or more fields, each having a specific number of symbols The payload 420 may include various formatting information. In certain embodiments, payload 420 may span a time interval (herein referred to as “length”) as long as about 87 ms=(2¹⁶ octets)×(8 bits/6 Mbps), where 6 Mbps may be lowest information rate of a protocol utilized for wireless transmissions. As such, for an information rate f, the length of the payload 420 may be τ=(2¹⁶ octets)×(8 bits)×f¹. In one example, the length of the payload field may be about 5 ms. The number of bits in the payload 420 may be determined by the modulation scheme (e.g., BPSK) utilized to transmit the NB-RA request frame 400.

The information in the legacy preamble 410, and the number of fields and specific content of each field (both of which may be referred to as “field structure”) in the payload 420 may be modulated or otherwise formatted in numerous ways. In certain embodiments, as described herein, the STA may modulate the NB-RA request frame 400 according to on-off keying (OOK). In other embodiments, as described herein, the STA may encode the NB-RA request frame 400 according to eight-times (8×) repetition coding or, more generally, any other p-times repetition coding, with p a natural number greater than unity.

More specifically, in certain embodiments, such as in the example frame 400 illustrated in FIG. 4, the legacy preamble 402 may include three legacy fields: legacy short training field (L-STF) 402, legacy long training field (L-LTF) 404, and legacy signal (L-SIG) field 406. Each of such fields may include one or more symbols. The L-STF 402 may include two symbols, the L-LTF 404 may include two symbols, and the L-SIG field 406 may include one symbol. In addition, the payload 420 may embody the payload 320 and may include a preamble 408, a MAC header field 412 (or MAC header 412), a content field 414, and a validation field 416, which is illustrated as a frame check sequence (FCS) field 416. As described herein, in certain embodiments, the payload 420 may span a time interval as long as about 87 ms. In one embodiment, the length of the payload field may be about 5 ms. The number of bits in the payload 570 may be determined by the modulation scheme utilized to transmit the NB-RA request frame 400. In certain embodiments, the preamble 408 may include 16 bits.

In one aspect, the MAC header 412 may convey that the frame 400 is an NB-RA frame and the content field 414 may include identification (e.g., a STA-ID or other type of ID code) of the STA that generates and/or sends the frame 400. As illustrated, the validation field 416 may be embodied in a FCS field 416 computed or otherwise determined as a checksum of the MAC header 412 and the content field 414. As described herein, in certain implementations, the checksum may be determined via a bitwise XOR operation between the MAC header 412 and at least a portion of the content field 414. In certain embodiments, the MAC header 412 may include 16 bits and the content field 414 may include 96 bits. It should be appreciated that the disclosure is limited with respect to the number of bits in the preamble 408, the MAC header 412, and/or the content field 414, and such fields may include other number of bits besides those exemplified herein.

The example frame 400 may be modulated according to OOK. For example, each OFDM symbol (which may span about 4 microseconds) may indicate one bit information resulting in a (4 μs)⁻¹=250 kbps physical (PHY) layer rate. It should be appreciated that, in one aspect, non-coherent OOK may have a bit error rate (BER) that is 4 dB higher than that of binary phase shift keying (BPSK), which may have a BER of about 10⁻⁴. Yet, since the data rate is about 24 times lower than the lowest MCS (e.g., data rate of 6 Mbps) in a 20 MHz packet, the OOK at 250 kbps may achieve 10 dB (e.g., nearly 13.8 dB−4 dB) better link budget than BPSK at 6 Mbps. As such, OOK modulation as described herein may close the link from the STA to an AP operating in a Δ channel. The foregoing analysis applies to embodiments in which a 20 MHz receiver at the AP is assumed to be a simple receiver design. In other embodiments, the design approach of the AP receiver may be to have two receive branches where one branch processes the signal as if it is a 20 MHz signal and the other branch processes the received signal after any legacy preambles with a narrow band receiver. In a scenario in which 2.5 MHz transmissions from the STA are present (via, for example, 7 or 8 subcarriers OOK), another 9 dB better link budget may be achieved. Therefore, in certain embodiments, the NB-RA frame may be sent from the STA at a total of about 19 dB better link budget using OOK at 250 kbps data rate, for example. In certain embodiments, a simple OOK demodulator may be implemented at the AP in parallel with an orthogonal frequency-division multiplexing (OFDM) demodulator to receive an OOK modulated packet.

FIG. 5 illustrates another example of a NB-RA request frame in accordance with one or more embodiments of the disclosure. A station may encode the frame 500 according to eight-times (8×) repetition coding in order to close the uplink between the station and an AP. The example frame 500 may include a legacy preamble 510 formed by a L-STF 502, a L-LTF 504, and a L-SIG field 506. In one example, each of such fields may include two symbols. In addition, following the legacy preamble 510, three fields according to IEEE 802.11ax protocol (or high efficiency wireless local area network (HEW) may be included in the example frame 500: a high-efficiency (HE) short training field (HE-STF) 508, a HE long training field (HE-LTF) 518, and a HE signal (HE-SIG) field 522. In 8× coding, the station may include 16 symbols in each of HE-STF 508, HE-LTF 518, and HE-SIG field 522. In addition, the example frame 500 may include payload 520 encoded according to 8× repetition encoding. In certain embodiments, the payload 520 may span a time interval as long as about 87 ms. In one example, the length of the payload 520 may be about 5 ms. The number of bits in the payload 508 may be determined by the modulation scheme utilized to transmit the NB-RA request frame 400. As illustrated, the payload 520 may include a MAC header 512, a content field 514, and a validation field 516. Similar to the payload 420, the MAC header 512 may convey that the example frame is NB-RA frame, and the content field 514 may convey identification (e.g., a STA-ID code or other type of code) of the STA that generates and/or sends the example frame 500. The validation field 516 may include a FCS or other type of validation information, such as a CRC, computed or otherwise determined as a frame check sequence of the MAC header 512 and the content 514. As described herein, the legacy fields 502, 504, and 506 may provide information for coexistence to 3^{rd} party legacy 802.11 stations. The AP may not be able to receive the legacy 802.11 preamble correctly due to link-budget imbalance aspects described herein. As such, the AP may rely on or otherwise leverage the fields coded with eight-times (8×) repetition coding following the legacy preamble 510 formed by the fields 502, 504, and 506.

For enabling detection of 11n/11ac/11ax networks, the modulation of HE-SIG-A1 and HE-SIG-A2 may be kept the same as L-SIG which uses ordinary binary phase-shift keying (BPSK) without rotation. In addition, the symbol duration and cyclic prefix (CP) duration may also be the same for L-SIG, HE-SIG-A1, and HE-SIG-A2. HE-SIG-A symbols may be of 20 MHz bandwidth and HE-SIG-B symbols may be 20 MHz or wider, e.g., 80 MHz. It should be noted, however, that legacy devices may treat the preamble as a IEEE 802.11a preamble. The number of HE-SIG-A symbols may be two or more. Similarly, the number of HE-SIG-B symbols may be two or more.

According to one example embodiment, a method may be provided for additional signaling information to 802.11ax (HEW—High Efficiency Wi-Fi) Wi-Fi devices. This new technique may be afforded through the use of orthogonal sequences. Therefore, the signaling does not require any bits to be allocated in a new HE-SIG field definition. Currently in the DensiFi SIG, there have been a few proposals on preamble structure. The issue is, with all the modes being proposed, the ways to signal these configurations requires using the HE-SIG or by inverted copy of duplicated L-SIG. These approaches either suffer performance degradation in outdoor environments or cause an increase in the preamble overhead. Furthermore, to improve performance in outdoor channels, duplication of symbols or increased guard interval has been proposed, which may increase the overhead to the entire system. Therefore, any and all approaches need to be utilized to minimize the bit field allocations in the HE-SIG. Example embodiments disclosed may also be used as a method of 11ax classification.

According to one example embodiment, a design target for HEW is to adopt methods to improve the efficiency of Wi-Fi, and specifically the efficiency in dense deployments. With each new amendment to the Wi-Fi standard, additional signaling is required so the subsequent amended systems may identify each transmission and categorize it and inform the receiver as to the configuration of that transmission. In Wi-Fi, to maintain legacy capability, the preamble portion of the packet has been increased and new fields added with various modulation formats so that the new releases could be identified.

Example embodiments disclosed provide an approach of adding a 1× symbol duration (4 micro sec) after the legacy SIG field (L-SIG) which carries one of the pre-defined orthogonal sequences to provide additional signaling to HEW devices. The legacy portion of the preamble, at least up to and including the L-STF/L-LTF and L-SIG, may be included in the 802.11ax transmission. The length field in the L-SIG may be used in some context to help identify a transmission as coming from either a legacy system or from an 802.11ax system. One example design here is to use the length field in L-SIG to defer legacy devices, and then to use the symbol that follows L-SIG to provide signaling information as to the type of 802.11ax preamble or packet.

According to one or more example embodiment, detection of the added symbol may also be used as a method of flax classification, although other methods such as setting length field (in L-SIG) to a value non-divisible by 3 may be used as a classification method along with methods such as repeat of L-SIG or repeat of HE-SIG-A.

According to one or more example embodiments, orthogonal sequences may be used to signal various things. One advantage is that since this occurs at the beginning of the packet, before any HE signaling, the signaling may then convey things like length of the guard interval for the HE payload, or even to signal different preamble configurations for indoor vs. outdoor deployments. Thus, this provides an added advantage that different configurations could be used immediately after the L-SIG, so that the receiver would know the configurations after detecting which orthogonal sequence is used in this packet.

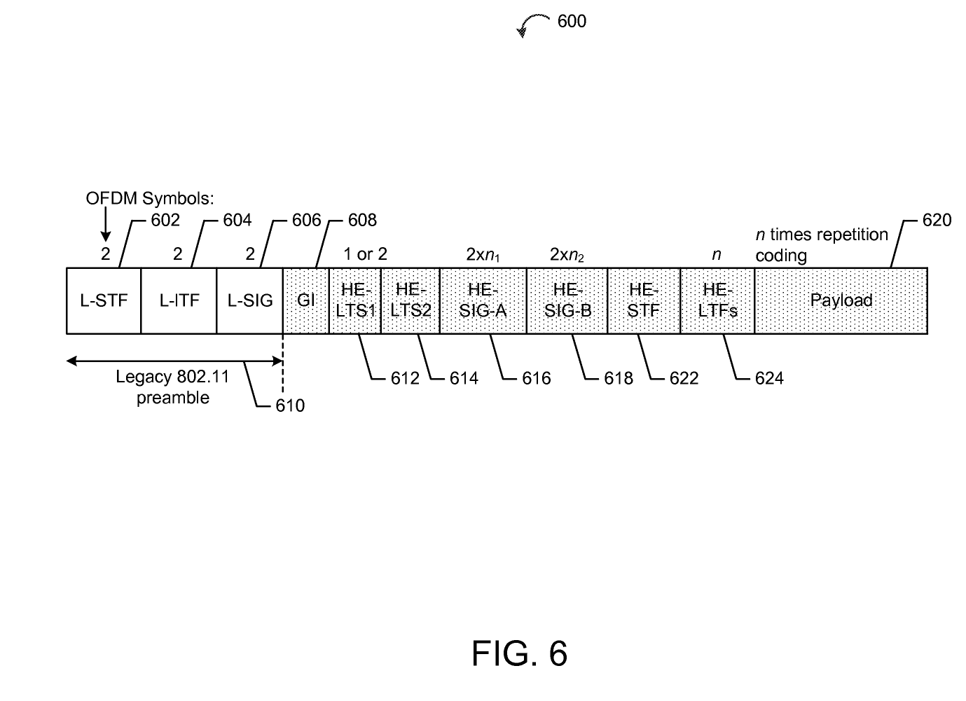

Turning now to FIG. 6, illustrated is an example packet 600 where one or more symbol(s) of High Efficiency Long Training Sequence(s) (HE-LTS) 612, 614 may added after the legacy signal field L-SIG 606. Packet or frame 600 may include a legacy preamble portion 610, a payload portion 620, a guard interval portion 608, one or more HE-LTSs 612, 614, HE-SIG-A portion 616, HE-SIG-B portion 618, HE short training field 622, and HE long training field 624. The symbols 612, 614 that follow L-SIG 606 may be modulated BPSK such that the packet in FIG. 6 may look like 11a packet to legacy devices. Legacy devices may defer correctly by the value of length set in L-SIG 606. The 11ax receiver or the low power OOK or Rep8 802.11ax receiver may search for detection of the newly defined differentially orthogonal HE-LTS 612, 614, which may consist of one long training sequence 612 and possibly a second repetition of that 614, to distinguish between 11ax and low power 11ax receiver. According to one example embodiment, the detailed binary definition of sequences for HE may be (1) differentially orthogonal, (2) have good peak-to-average power ratio (PAPR), and (3) good 11ax detection properties in both indoor channel and outdoor channel. Example embodiments disclosed herein define an 11ax packet structure with the added binary sequence as one OFDM symbol (or two symbols if most reliable wideband performance is desired) after L-SIG that is used for classifications of 11ax from OOK or Rep8 802.11ax and even from 11a/g/n/ac packets.

Example characteristics of the proposed High-Efficiency Long Training Sequences may include at least a first characteristic where at least two sequences are defined that are differentially orthogonal, named HE-LTS1 and HE-LTS2. HE-LTS1 may be used for 11ax packet and HE-LTS2 may be used for 11ax low power packet. It is possible to define more than two such sequences to signal more information, for example HE-LTS3 may be defined to identify an indoor 11ax packet. This may, however, require the receiver to perform additional hypothesis testing.

HE-LT sequences may be differentially orthogonal as defined as follows. For generalization and providing more degree of freedom to finding the desired binary sequences, the formula below may be given for block-by-block differentially orthogonal sequences. Considering a binary preamble sequence HE-LTS1 is transmitted, let R be the received preamble symbol after being passed through a channel H, and undergoing an N-point FFT operation. Receiver divides the received sequence R, and known preamble sequences HE-LTSs into two blocks of size N_{B1} and N_{B2} (or N_{B1}, N_{B2}, . . . , N_{BL} as a generalization). Receiver may have a frequency domain differential detector defined as:

$$BDD ( R , P ) = {\sum }_{l} {DD}_{Bl} ( {R}_{l} , {P}_{l} )$$

Where, P is the pre-defined preamble sequences or HE-LTSs

$$\begin{matrix}{DD}_{Bl} ( {R}_{l} , {P}_{l} ) = {\sum }_{k = 1}^{{N}_{Bl} - 1} ( {r}_{l , k} {r}_{l , k + 1}^{*} ) \cdot {( {p}_{l , k} {p}_{l , k + 1}^{*} )}^{*} \\ = {\sum }_{k = 1}^{{N}_{Bl} - 1} [ ( {p}_{l , k} {h}_{l , k} + {n}_{l , k} ) ( {p}_{l , k + 1}^{*} {h}_{l , k + 1}^{*} + {n}_{l , k + 1} ) ] \cdot {( {p}_{l , k} {p}_{l , k + 1}^{*} )}^{*} \\ \approx {\sum }_{k = 1}^{{N}_{B 1} - 1} {h}_{l , k} {h}_{l , k + 1}^{*} \approx {\sum }_{k = 1}^{{N}_{B 1} - 1} {\vert {h}_{l , k} \vert}^{2}\end{matrix}$$

and where r_{l,k} and p_{l,k} are frequency domain representation of the k-th element in sequences R, and P in Block N_{Bl}.
Note that for a binary sequence pₖp*ₖ₊₁=±1.
BDD(R,P) indicates if symbol R includes frequency domain sequence {p₁, p₂, . . . , p_{N}}, allowing classification of the transmitted preamble HE-LTS₁ from another preamble sequence HE-LTS₂, by examining

$${arg max \{ BDD ( R , P ) \}}_{P ∈ \{ HE - {LTS}_{1} , HE - {LTS}_{2} \}}$$

assuming that the two sequences P, Qε{HE-LTS₁, HE-LTS₂} are block-by-block differentially orthogonal as defined by

$${\sum }_{k = 1}^{{N}_{Bl} - 1} ( {p}_{l , k} {p}_{l , k + 1}^{*} ) \cdot {( {q}_{l , k} {q}_{l , k + 1}^{*} )}^{*} = 0$$

A second characteristic may include a low peak-to-average power ratio (PAPR). PAPR may be defined as the ratio of the peak power level to the time-averaged power level in an electrical circuit. A PAPR meter may be used as a means to identify degraded telephone channels. PAPR meters are very sensitive to envelope delay distortion, and may also be used for idle channel noise, nonlinear distortion, and amplitude-distortion measurements. The peak-to-average ratio may be determined for many signal parameters, such as voltage, current, power, frequency, and phase.

A third characteristic may include good detection performance in both indoor and outdoor channels. A fourth characteristic may include HE-LTS may be transmitted over 80 MHz bandwidth to further provide wideband channel estimation for 11ax devices. This may enable transmission of wideband HE-SIGA and HE-SIGB, for example. According to one example embodiment, the idea of wideband may even get extended to 4× symbol duration to provide 256, 512 and 1024 (and (1024+1024)/2048) channel estimates for 20 MHZ, 40 MHz, and 80 MHz (and 160 MHz) bandwidths. This may also include low probability of misclassification of 11ax (and OOK or Rep8 802.11ax) packets by 11n devices as 11n packet. This may also include low probability of misclassification of legacy packets by 11ax (and OOK/Rep8 802.11ax) devices as 11ax packets.

A fifth characteristic may include HE-LTS may be repeated to improve probability of detection and probability of false alarm in low signal-to-noise ratio (SNR) cases. In such cases, repetition may improve reliability of channel estimates if wideband transmission as explained in the fourth characteristic may also be desired. It should be noted, however, that one may use legacy LTF (or Legacy LTS) as one choice for HE-LTF (HE-LTS) and search to find the second HE-LTS2 (and more HE-LTS3 . . . ) that is (are) differentially orthogonal to legacy sequence and each other.

Example embodiment disclosed herein may, for example, be a part of 802.11ax spec and used to solve the uplink/downlink link-budget problem with backward compatibility to legacy 802.11a/n/ac devices and allow low power and low cost 802.11 devices to associate with an AP.

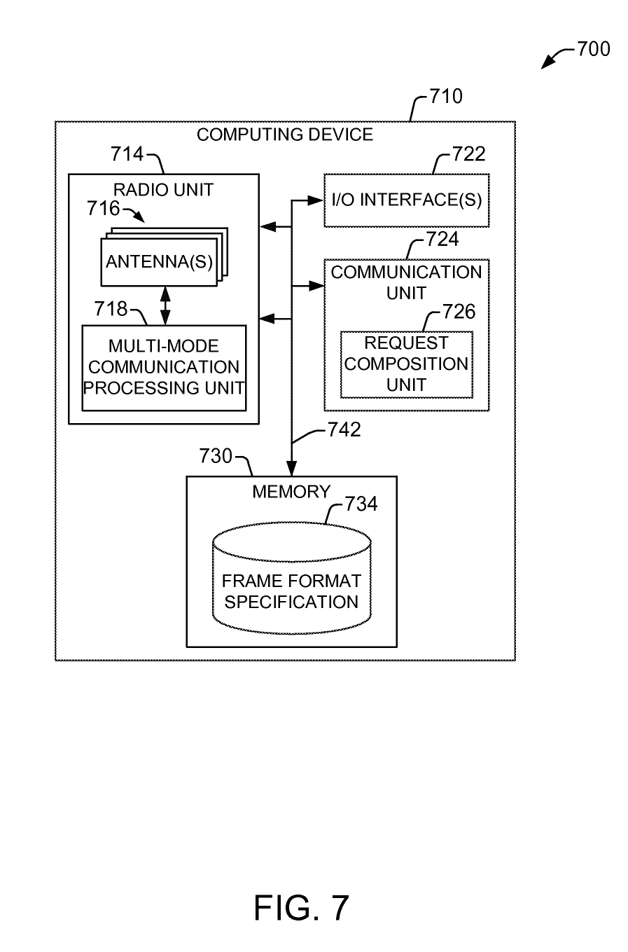

FIG. 7 illustrates a block-diagram of an example embodiment 700 of a computing device 710 that may operate in accordance with at least certain aspects of the disclosure. In one aspect, the computing device 710 may operate as a wireless device and may embody or may comprise an access point, a mobile computing device (e.g., a station or other type of user equipment), or other type of communication device that may transmit and/or receive wireless communications in accordance with this disclosure. To permit wireless communication, including the scheduling of resource block allocations as described herein, the computing device 710 includes a radio unit 714 and a communication unit 724. In certain implementations, the communication unit 724 may generate packets or other type of information blocks via a network stack, for example, and may convey the packets or other type of information block to the radio unit 714 for wireless communication. In one embodiment, the network stack (not shown) may be embodied in or may constitute a library or other type of programming module, and the communication unit 724 may execute the network stack in order to generate a packet or other type of information block. Generation of the packet or the information block may include, for example, generation of control information (e.g., checksum data, communication address(es)), traffic information (e.g., payload data), and/or formatting of such information into a specific packet header.

As illustrated, the radio unit 714 may include one or more antennas 716 and a multi-mode communication processing unit 718. In certain embodiments, the antenna(s) 716 may be embodied in or may include directional or omnidirectional antennas, including, for example, dipole antennas, monopole antennas, patch antennas, loop antennas, microstrip antennas or other types of antennas suitable for transmission of RF signals. In addition, or in other embodiments, at least some of the antenna(s) 716 may be physically separated to leverage spatial diversity and related different channel characteristics associated with such diversity. In addition or in other embodiments, the multi-mode communication processing unit 718 that may process at least wireless signals in accordance with one or more radio technology protocols and/or modes (such as MIMO, single-input-multiple-output (SIMO), multiple-input-single-output (MISO), and the like. Each of such protocol(s) may be configured to communicate (e.g., transmit, receive, or exchange) data, metadata, and/or signaling over a specific air interface. The one or more radio technology protocols may include 3^{rd} Generation Partnership Project (3GPP) Universal Mobile Telecommunication System (UMTS); 3GPP Long Term Evolution (LTE); LTE Advanced (LTE-A); Wi-Fi protocols, such as those of the Institute of Electrical and Electronics Engineers (IEEE) 802.11 family of standards; Worldwide Interoperability for Microwave Access (WiMAX); radio technologies and related protocols for ad hoc networks, such as Bluetooth or ZigBee; other protocols for packetized wireless communication; or the like). The multi-mode communication processing unit 718 also may process non-wireless signals (analogic, digital, a combination thereof, or the like). While illustrated as separate blocks in the computing device 710, it should be appreciated that in certain embodiments, at least a portion of the multi-mode communication processing unit 718 and the communication unit 724 may be integrated into a single unit (e.g., a single chipset or other type of solid state circuitry).

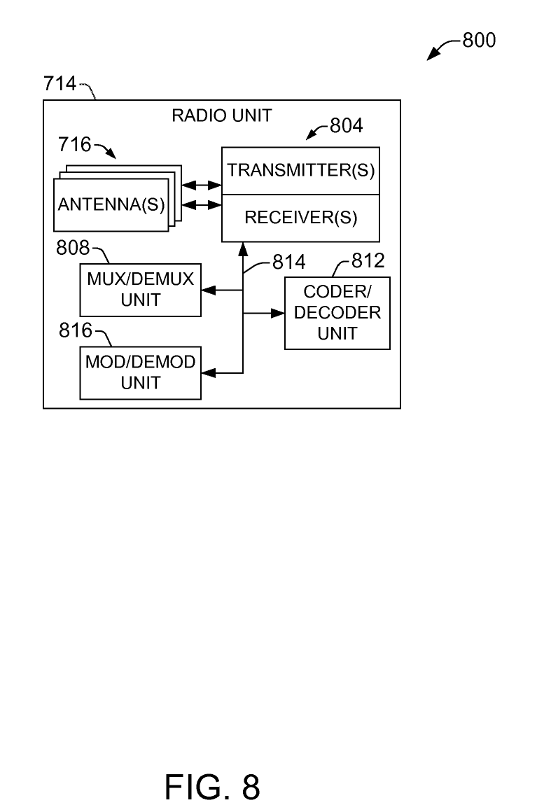

In one embodiment, e.g., example embodiment 800 shown in FIG. 8, the multi-mode communication processing unit 718 may comprise a set of one or more transmitters/receivers 804, and components therein (amplifiers, filters, analog-to-digital (A/D) converters, etc.), functionally coupled to a multiplexer/demultiplexer (mux/demux) unit 808, a modulator/demodulator (mod/demod) unit 816 (also referred to as modem 816), and a coder/decoder unit 812 (also referred to as codec 812). Each of the transmitter(s)/receiver(s) may form respective transceiver(s) that may transmit and receive wireless signal (e.g., electromagnetic radiation) via the one or more antennas 716. It should be appreciated that in other embodiments, the multi-mode communication processing unit 718 may include other functional elements, such as one or more sensors, a sensor hub, an offload engine or unit, a combination thereof, or the like.

Electronic components and associated circuitry, such as mux/demux unit 808, codec 812, and modem 816 may permit or facilitate processing and manipulation, e.g., coding/decoding, deciphering, and/or modulation/demodulation, of signal(s) received by the computing device 710 and signal(s) to be transmitted by the computing device 710. In one aspect, as described herein, received and transmitted wireless signals may be modulated and/or coded, or otherwise processed, in accordance with one or more radio technology protocols. Such radio technology protocol(s) may include 3GPP UMTS; 3GPP LTE; LTE-A; Wi-Fi protocols, such as IEEE 802.11 family of standards (IEEE 802.ac, IEEE 802.ax, and the like); WiMAX; radio technologies and related protocols for ad hoc networks, such as Bluetooth or ZigBee; other protocols for packetized wireless communication; or the like.

The electronic components in the described communication unit, including the one or more transmitters/receivers 804, may exchange information (e.g., data, metadata, code instructions, signaling and related payload data, combinations thereof, or the like) through a bus 814, which may embody or may comprise at least one of a system bus, an address bus, a data bus, a message bus, a reference link or interface, a combination thereof, or the like. Each of the one or more receivers/transmitters 804 may convert signal from analog to digital and vice versa. In addition or in the alternative, the receiver(s)/transmitter(s) 804 may divide a single data stream into multiple parallel data streams, or perform the reciprocal operation. Such operations may be conducted as part of various multiplexing schemes. As illustrated, the mux/demux unit 808 is functionally coupled to the one or more receivers/transmitters 804 and may permit processing of signals in time and frequency domain. In one aspect, the mux/demux unit 808 may multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition or in the alternative, in another aspect, the mux/demux unit 808 may scramble and spread information (e.g., codes) according to most any code, such as Hadamard-Walsh codes, Baker codes, Kasami codes, polyphase codes, and the like. The modem 816 may modulate and demodulate information (e.g., data, metadata, signaling, or a combination thereof) according to various modulation techniques, such as frequency modulation (e.g., frequency-shift keying), amplitude modulation (e.g., M-ary quadrature amplitude modulation (QAM), with M a positive integer; frequency shift keying (FSK); amplitude-shift keying (ASK)), phase-shift keying (PSK), and the like). In addition, processor(s) that may be included in the computing device 810 (e.g., processor(s) included in the radio unit 714 or other functional element(s) of the computing device 810) may permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 812 may operate on information (e.g., data, metadata, signaling, or a combination thereof) in accordance with one or more coding/decoding schemes suitable for communication, at least in part, through the one or more transceivers formed from respective transmitter(s)/receiver(s) 804. In one aspect, such coding/decoding schemes, or related procedure(s), may be retained as a group of one or more computer-accessible instructions (computer-readable instructions, computer-executable instructions, or a combination thereof) in one or more memory devices 730 (herein referred to as memory 730). In a scenario in which wireless communication among the computing device 710 and another computing device (e.g., a station or other type of user equipment) utilizes MIMO, MISO, SIMO, or SISO operation, the codec 812 may implement at least one of space-time block coding (STBC) and associated decoding, or space-frequency block (SFBC) coding and associated decoding. In addition or in the alternative, the codec 812 may extract information from data streams coded in accordance with spatial multiplexing scheme. In one aspect, to decode received information (e.g., data, metadata, signaling, or a combination thereof), the codec 812 may implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 812 may utilize, at least in part, mux/demux unit 808 and mod/demod unit 816 to operate in accordance with aspects described herein.

With further reference to FIG. 7, the computing device 710 may operate in a variety of wireless environments having wireless signals conveyed in different electromagnetic radiation (EM) frequency bands. To at least such end, the multi-mode communication processing unit 718 in accordance with aspects of the disclosure may process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion of the EM spectrum. In one aspect, the set of one or more frequency bands may include at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

The computing device 710 may receive and/or transmit information encoded and/or modulated or otherwise processed in accordance with aspects of the present disclosure. To at least such an end, in certain embodiments, the computing device 710 may acquire or otherwise access information, wirelessly via the radio unit 714 (also referred to as radio 714), where at least a portion of such information may be encoded and/or modulated in accordance with aspects described herein. More specifically, for example, the information may include association requests, NB-RA requests, resource allocations, ACK frames, and/or other type of packets (e.g., PPDUs) in accordance with embodiments of the disclosure. For example, an NB-RA request may be formatted as shown in FIGS. 2-5. As illustrated, the computing device 710 may include one or more memory elements 734 (referred to frame format specification 734) that may include information defining or otherwise specifying one or more formats for composition or otherwise generation of a NB-RA request frame. The communication unit 724 may access at least a portion of the information in the frame format specification 734 and may generate a NB-RA request having a format in accordance with one of those described in FIGS. 2-5. To that end, the communication unit 724 may include a request composition unit 726 that may generate the NR-RA request. As described herein, the NR-RA request may be included in or may embody a PPDU.

The memory 730 may contain one or more memory elements having information suitable for processing information received according to a predetermined communication protocol (e.g., IEEE 802.11ac, IEEE 802.11ax, or the like). While not shown, in certain embodiments, one or more memory elements of the memory 730 may include computer-accessible instructions that may be executed by one or more of the functional elements of the computing device 710 in order to implement at least some of the functionality for association between communication devices (e.g., a STA and an AP) in accordance with aspects described herein, including processing of information communicated (e.g., encoded, modulated, and/or arranged) in accordance with an aspect of the disclosure. One or more groups of such computer-accessible instructions may embody or may constitute a programming interface that may permit communication of information (e.g., data, metadata, and/or signaling) between functional elements of the computing device 710 for implementation of such functionality.

As illustrated, the communication device 710 may include one or more I/O interfaces 722. At least one of the I/O interface(s) 722 may permit the exchange of information between the computing device 710 and another computing device and/or a storage device. Such an exchange may be wireless (e.g., via near field communication or optically-switched communication) or wireline. At least another one of the I/O interface(s) 722 may permit presenting information visually and/or aurally to an end-user of the computing device 710. In addition, two or more of the functional elements of the computing device 710 may exchange information (e.g., data, metadata, code instructions, signaling and related payload data, combinations thereof, or the like) through a bus 742, which may embody or may comprise at least one of a system bus, an address bus, a data bus, a message bus, a reference link or interface, a combination thereof, or the like. The bus 742 may include, for example, components for wireline and wireless communication.

It should be appreciated that portions of the computing device 710 may embody or may constitute an apparatus. For instance, the multi-mode communication processing unit 718, the communication unit 724, and at least a portion of the memory 730 may embody or may constitute an apparatus that may operate in accordance with one or more aspects of this disclosure.

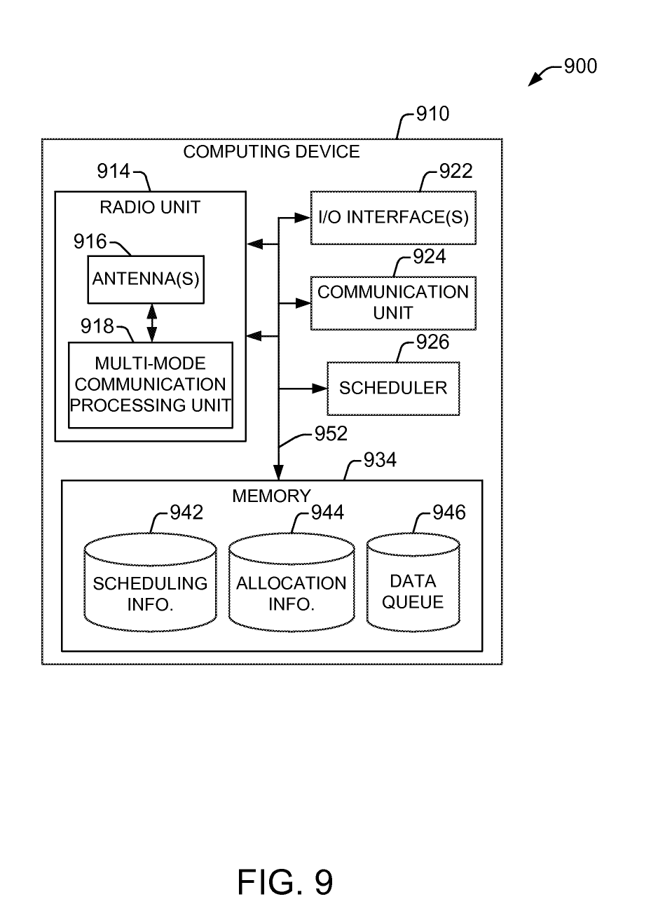

FIG. 9 illustrates a block-diagram of an example embodiment 900 of a computing device 910 that may operate in accordance with at least certain aspects of the disclosure. In one aspect, the computing device 910 may operate as a wireless device and may embody or may comprise an access point, such as AP 102 in accordance with this disclosure. To permit wireless communication, including the scheduling of resource block allocations as described herein, the computing device 910 includes a radio unit 914 and a communication unit 924. In certain implementations, the communication unit 924 may generate packets or other type of information blocks via a network stack, for example, and may convey the packets or other type of information block to the radio unit 914 for wireless communication. In one embodiment, the network stack (not shown) may be embodied in or may constitute a library or other type of programming module, and the communication unit 924 may execute the network stack in order to generate a packet or other type of information block. Generation of the packet or the information block may include, for example, generation of control information (e.g., checksum data, communication address(es)), traffic information (e.g., payload data), and/or formatting of such information into a specific packet header.

As illustrated, the radio unit 914 may include one or more antennas 916 and a multi-mode communication processing unit 919. In certain embodiments, the antenna(s) 916 may be embodied in or may include directional or omnidirectional antennas, including, for example, dipole antennas, monopole antennas, patch antennas, loop antennas, microstrip antennas or other types of antennas suitable for transmission of RF signals. In addition, or in other embodiments, at least some of the antenna(s) 916 may be physically separated to leverage spatial diversity and related different channel characteristics associated with such diversity. In addition or in other embodiments, the multi-mode communication processing unit 919 that may process at least wireless signals in accordance with one or more radio technology protocols and/or modes (such as MIMO, single-input-multiple-output (SIMO), multiple-input-single-output (MISO), and the like). Each of such protocol(s) may be configured to communicate (e.g., transmit, receive, or exchange) data, metadata, and/or signaling over a specific air interface. The one or more radio technology protocols may include 3GPP UMTS; LTE; LTE-A; Wi-Fi protocols, such as those of the IEEE 802.11 family of standards; WiMAX; radio technologies and related protocols for ad hoc networks, such as Bluetooth or ZigBee; other protocols for packetized wireless communication; or the like). The multi-mode communication processing unit 918 also may process non-wireless signals (analogic, digital, a combination thereof, or the like). While illustrated as separate blocks in the computing device 600, it should be appreciated that in certain embodiments, at least a portion of the multi-mode communication processing unit 718 and the communication unit 724 may be integrated into a single unit (e.g., a single chipset or other type of solid state circuitry).

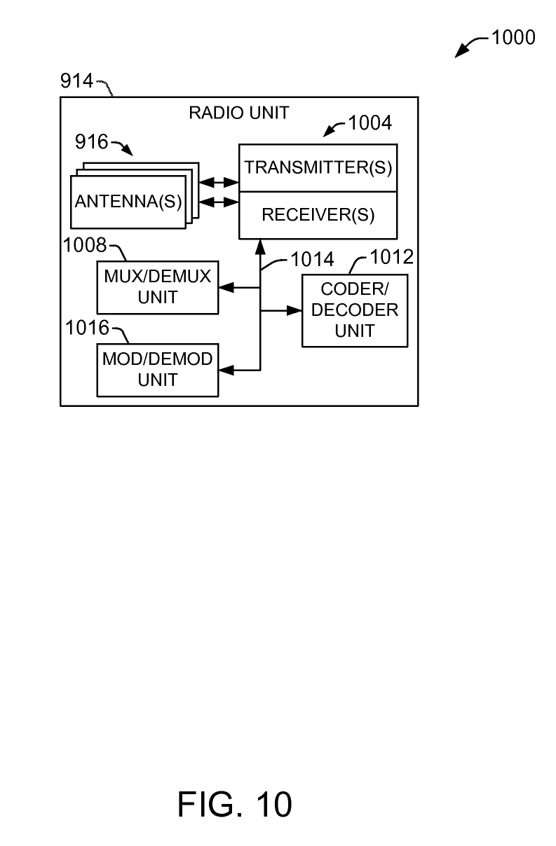

In one embodiment, e.g., example embodiment 1000 shown in FIG. 10, the multi-mode communication processing unit 918 may comprise a set of one or more transmitters/receivers 1004, and components therein (amplifiers, filters, analog-to-digital (A/D) converters, etc.), functionally coupled to a multiplexer/demultiplexer (mux/demux) unit 1008, a modulator/demodulator (mod/demod) unit 1016 (also referred to as modem 1016), and a coder/decoder unit 1012 (also referred to as codec 1012). Each of the transmitter(s)/receiver(s) may form respective transceiver(s) that may transmit and receive wireless signal (e.g., electromagnetic radiation) via the one or more antennas 916. It should be appreciated that in other embodiments, the multi-mode communication processing unit 918 may include other functional elements, such as one or more sensors, a sensor hub, an offload engine or unit, a combination thereof, or the like.

Electronic components and associated circuitry, such as mux/demux unit 1008, codec 1012, and modem 1016 may permit or facilitate processing and manipulation, e.g., coding/decoding, deciphering, and/or modulation/demodulation, of signal(s) received by the computing device 1010 and signal(s) to be transmitted by the computing device 1010. In one aspect, as described herein, received and transmitted wireless signals may be modulated and/or coded, or otherwise processed, in accordance with one or more radio technology protocols. Such radio technology protocol(s) may include 3GPP UMTS; 3GPP LTE; LTE-A; Wi-Fi protocols, such as IEEE 802.11 family of standards (IEEE 802.ac, IEEE 802.ax, and the like; WiMAX; radio technologies and related protocols for ad hoc networks, such as Bluetooth or ZigBee; other protocols for packetized wireless communication; or the like.

The electronic components in the described communication unit, including the one or more transmitters/receivers 1004, may exchange information (e.g., data, metadata, code instructions, signaling and related payload data, combinations thereof, or the like) through a bus 1014, which may embody or may comprise at least one of a system bus, an address bus, a data bus, a message bus, a reference link or interface, a combination thereof, or the like. Each of the one or more receivers/transmitters 1004 may convert signal from analog to digital and vice versa. In addition or in the alternative, the receiver(s)/transmitter(s) 1004 may divide a single data stream into multiple parallel data streams, or perform the reciprocal operation. Such operations may be conducted as part of various multiplexing schemes. As illustrated, the mux/demux unit 1008 is functionally coupled to the one or more receivers/transmitters 1004 and may permit processing of signals in time and frequency domain. In one aspect, the mux/demux unit 1008 may multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition or in the alternative, in another aspect, the mux/demux unit 1008 may scramble and spread information (e.g., codes) according to most any code, such as Hadamard-Walsh codes, Baker codes, Kasami codes, polyphase codes, and the like. The modem 1016 may modulate and demodulate information (e.g., data, metadata, signaling, or a combination thereof) according to various modulation techniques, such as frequency modulation (e.g., frequency-shift keying), amplitude modulation (e.g., M-ary quadrature amplitude modulation (QAM), with M a positive integer; amplitude-shift keying (ASK), phase-shift keying (PSK), and the like). In addition, processor(s) that may be included in the computing device 810 (e.g., processor(s) included in the radio unit 914 or other functional element(s) of the computing device 810) may permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 1012 may operate on information (e.g., data, metadata, signaling, or a combination thereof) in accordance with one or more coding/decoding schemes suitable for communication, at least in part, through the one or more transceivers formed from respective transmitter(s)/receiver(s) 1004. In one aspect, such coding/decoding schemes, or related procedure(s), may be retained as a group of one or more computer-accessible instructions (computer-readable instructions, computer-executable instructions, or a combination thereof) in one or more memory devices 934 (referred to as memory 934). In a scenario in which wireless communication among the computing device 810 and another computing device (e.g., a station or other type of user equipment) utilizes MIMO, MISO, SIMO, or SISO operation, the codec 1012 may implement at least one of space-time block coding (STBC) and associated decoding, or space-frequency block (SFBC) coding and associated decoding. In addition or in the alternative, the codec 1012 may extract information from data streams coded in accordance with spatial multiplexing scheme. In one aspect, to decode received information (e.g., data, metadata, signaling, or a combination thereof), the codec 1012 may implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 1012 may utilize, at least in part, mux/demux unit 1008 and mod/demod unit 1016 to operate in accordance with aspects described herein.

The computing device 910 may operate in a variety of wireless environments having wireless signals conveyed in different electromagnetic radiation (EM) frequency bands. To at least such end, the multi-mode communication processing unit 918 in accordance with aspects of the disclosure may process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion of the EM spectrum. In one aspect, the set of one or more frequency bands may include at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

The computing device 910 may receive and/or transmit information encoded and/or modulated or otherwise processed in accordance with aspects of the present disclosure. To at least such an end, in certain embodiments, the computing device 910 may acquire or otherwise access information, wirelessly via the radio unit 914 (also referred to as radio 914). For example, the computing device 910 may receive a NB-RA request from another communication device (e.g., communication device 104). In the illustrated embodiment, the computing device 910 includes a scheduler unit 926 (also referred to as scheduler 926) that may access scheduling information and may schedule or otherwise allocate a resource block the communication device. As described herein, the allocated resource block may be a narrow frequency bandwidth allocation (e.g., 2.5 MHz). In certain implementations, the scheduling information may include intended quality-of-service (QoS), such as intended data rate; signal strength; interference level; estimated distance between the communication device and the communication device 910; amount of traffic (or data) available or otherwise queued for the communication device being scheduled; and/or other type of scheduling factors. In addition or in other embodiments, the scheduling information may include information indicative or otherwise representative of modulation and coding schemes (MCSs) that may be assigned to a communication device that is being scheduled. The scheduling information may be retained in one or more memory devices 934 (referred to as memory 934) within one or more memory elements 942 (referred to as scheduling info. 942, which may be embodied in or may include registers, files, databases, and the like). Information indicative or otherwise representative of the traffic available to a communication device to be scheduled by the communication device 910 also may be retained in the memory 946 within one or more memory elements 946 (referred to as data queue 946).

The communication device 910 may select or otherwise determine a specific resource block for another communication device. As described herein, the resource block may have a size corresponding to a combination of predetermined allocation sizes, e.g., 56 tones, 106 tones, 236 tones, 500 tones, and 1008 tones. The predetermined allocation sizes may be retained in the memory 934 within one or more memory elements 944 (referred to as allocation info. 944). In addition or in other embodiments, the allocation info. 944 may include a specification of a frame format in which a NB-RA request may be received at the computing device 910. For instance, the allocation info. 944 may include information indicative or otherwise representative of the frame formats illustrated and described in connection with FIGS. 2-5. Upon or after the communication device 910 determines a resource block to be allocated (e.g., a narrowband resource block), the communication device 910 may transmit resource allocation information that may indicate the resource block (e.g., 236 tones) allocated to the communication device and the MCS that the communication device is to utilize for wireless transmissions. For communication of traffic and/or signaling, the AP 102, via the communication unit 924, for example, may form a wireless transmission for the communication device using the determined resource block and related allocation sizes.

In addition to scheduling info. 942, allocation info. 944, and data queue 946, the memory 934 may contain one or more memory elements having information suitable for processing information received according to a predetermined communication protocol (e.g., IEEE 802.11ac or IEEE 802.11ax). While not shown, in certain embodiments, one or more memory elements of the memory 934 may include computer-accessible instructions that may be executed by one or more of the functional elements of the computing device 910 in order to implement at least some of the functionality for association between communication devices (e.g., a STA and an AP) in accordance with aspects described herein, including processing of information communicated (e.g., encoded, modulated, and/or arranged) in accordance with aspect of the disclosure. One or more groups of such computer-accessible instructions may embody or may constitute a programming interface that may permit communication of information (e.g., data, metadata, and/or signaling) between functional elements of the computing device 910 for implementation of such functionality.

As illustrated, the communication device 910 may include one or more I/O interfaces 922. At least one of the I/O interface(s) 922 may permit the exchange of information between the computing device 910 and another computing device and/or a storage device. Such an exchange may be wireless (e.g., via near field communication or optically-switched communication) or wireline. At least another one of the I/O interface(s) 922 may permit presenting information visually and/or aurally to an end-user of the computing device 910. In addition, two or more of the functional elements of the computing device 910 may exchange information (e.g., data, metadata, code instructions, signaling and related payload data, combinations thereof, or the like) through a bus 952, which may embody or may comprise at least one of a system bus, an address bus, a data bus, a message bus, a reference link or interface, a combination thereof, or the like. The bus 952 may include, for example, components for wireline and wireless communication.

It should be appreciated that portions of the computing device 710 may embody or may constitute an apparatus. For instance, the multi-mode communication processing unit 919, the communication unit 924, and at least a portion of the memory 934 may embody or may constitute an apparatus that may operate in accordance with one or more aspects of this disclosure.

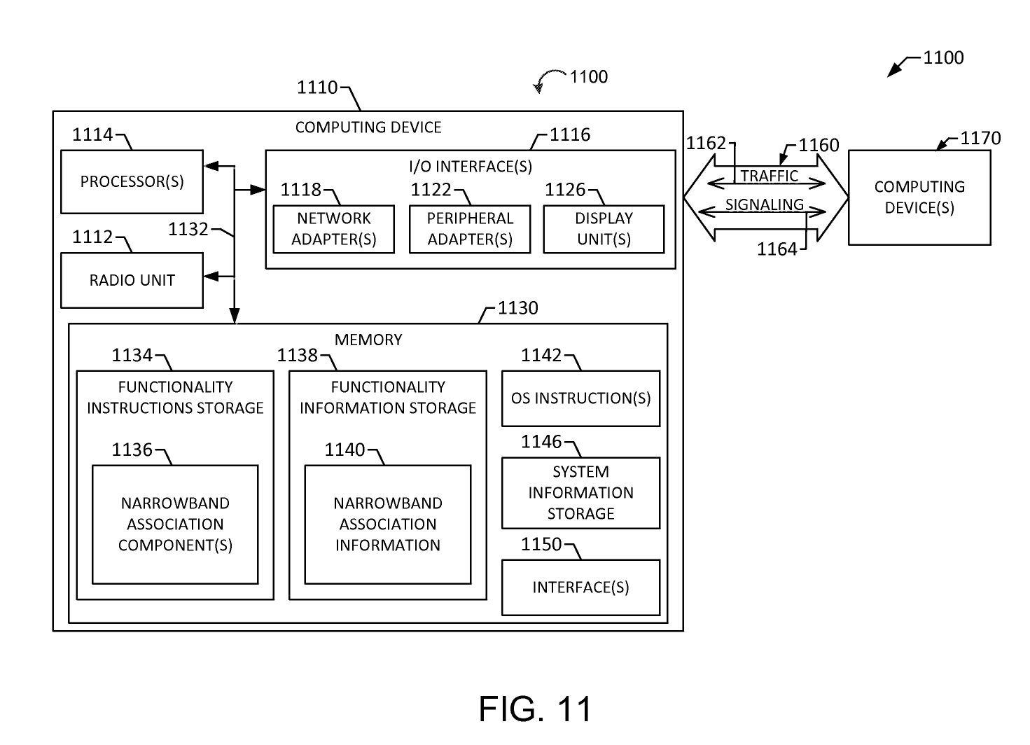

FIG. 11 illustrates an example of a computational environment 1100 for association between communication devices in accordance with one or more aspects of the disclosure. The example computational environment 1100 is only illustrative and is not intended to suggest or otherwise convey any limitation as to the scope of use or functionality of such computational environments' architecture. In addition, the computational environment 1100 should not be interpreted as having any dependency or requirement relating to any one or combination of components illustrated in this example computational environment. The illustrative computational environment 1100 may embody or may include the communication device 104, the AP 102, and/or any other computing device that may implement or otherwise leverage the NB-RA requests and other association features described herein.

The computational environment 1100 represents an example of a software implementation of the various aspects or features of the disclosure in which the processing or execution of operations described in connection with association between communication devices and related NB-RA requests described herein, including processing of information communicated (e.g., encoded, modulated, and/or arranged) in accordance with this disclosure, may be performed in response to execution of one or more software components at the computing device 1110. It should be appreciated that the one or more software components may render the computing device 1110, or any other computing device that contains such components, a particular machine for association between communication devices in accordance with aspects described herein, including processing of information encoded, modulated, and/or arranged in accordance with aspects described herein, among other functional purposes. A software component may be embodied in or may comprise one or more computer-accessible instructions, e.g., computer-readable and/or computer-executable instructions. At least a portion of the computer-accessible instructions may embody one or more of the example techniques disclosed herein. For instance, to embody one such method, at least the portion of the computer-accessible instructions may be persisted (e.g., stored, made available, or stored and made available) in a computer storage non-transitory medium and executed by a processor. The one or more computer-accessible instructions that embody a software component may be assembled into one or more program modules, for example, that may be compiled, linked, and/or executed at the computing device 1110 or other computing devices. Generally, such program modules comprise computer code, routines, programs, objects, components, information structures (e.g., data structures and/or metadata structures), etc., that may perform particular tasks (e.g., one or more operations) in response to execution by one or more processors, which may be integrated into the computing device 1110 or functionally coupled thereto.

The various example embodiments of the disclosure may be operational with numerous other general purpose or special purpose computing system environments or configurations. Examples of well-known computing systems, environments, and/or configurations that may be suitable for implementation of various aspects or features of the disclosure in connection with association between communication devices, including processing of information communicated (e.g., encoded, modulated, and/or arranged) in accordance with features described herein, may comprise personal computers; server computers; laptop devices; handheld computing devices, such as mobile tablets; wearable computing devices; and multiprocessor systems. Additional examples may include set top boxes, programmable consumer electronics, network PCs, minicomputers, mainframe computers, blade computers, programmable logic controllers, distributed computing environments that comprise any of the above systems or devices, and the like.

As illustrated, the computing device 1110 may include one or more processors 1114, one or more input/output (I/O) interfaces 1116, a memory 1130, and a bus architecture 1132 (also termed bus 1132) that functionally couples various functional elements of the computing device 1110. As illustrated, the computing device 1110 also may include a radio unit 1112. In one example, similarly to either the radio unit 714 or the radio unit 914, the radio unit 1112 may include one or more antennas and a communication processing unit that may permit wireless communication between the computing device 1110 and another device, such as one of the computing device(s) 1170. The bus 1132 may include at least one of a system bus, a memory bus, an address bus, or a message bus, and may permit exchange of information (data, metadata, and/or signaling) between the processor(s) 1114, the I/O interface(s) 1116, and/or the memory 1130, or respective functional elements therein. In certain scenarios, the bus 1132 in conjunction with one or more internal programming interfaces 1150 (also referred to as interface(s) 1150) may permit such exchange of information. In scenarios in which processor(s) 1114 include multiple processors, the computing device 1110 may utilize parallel computing.

The I/O interface(s) 1116 may permit or otherwise facilitate communication of information between the computing device and an external device, such as another computing device, e.g., a network element or an end-user device. Such communication may include direct communication or indirect communication, such as exchange of information between the computing device 1110 and the external device via a network or elements thereof. As illustrated, the I/O interface(s) 1116 may comprise one or more of network adapter(s) 1118, peripheral adapter(s) 1122, and display unit(s) 1126. Such adapter(s) may permit or otherwise facilitate connectivity between the external device and one or more of the processor(s) 1114 or the memory 1130. In one aspect, at least one of the network adapter(s) 1118 may couple functionally the computing device 1110 to one or more computing devices 1170 via one or more traffic and signaling pipes 1160 that may permit or facilitate exchange of traffic 1162 and signaling 1164 between the computing device 1110 and the one or more computing devices 1170. Such network coupling provided at least in part by the at least one of the network adapter(s) 1118 may be implemented in a wired environment, a wireless environment, or both. Therefore, it should be appreciated that in certain embodiments, the functionality of the radio unit 1112 may be provided by a combination of at least one of the network adapter(s) and at least one of the processor(s) 1114. Accordingly, in such embodiments, the radio unit 1112 may not be included in the computing device 1110. The information that is communicated by the at least one network adapter may result from implementation of one or more operations in a method of the disclosure. Such output may be any form of visual representation, including, but not limited to, textual, graphical, animation, audio, tactile, and the like. In certain scenarios, each of the computing device(s) 1170 may have substantially the same architecture as the computing device 1110. In addition or in the alternative, the display unit(s) 1126 may include functional elements (e.g., lights, such as light-emitting diodes; a display, such as liquid crystal display (LCD), combinations thereof, or the like) that may permit control of the operation of the computing device 1110, or may permit conveying or revealing operational conditions of the computing device 1110.

In one aspect, the bus 1132 represents one or more of several possible types of bus structures, including a memory bus or memory controller, a peripheral bus, an accelerated graphics port, and a processor or local bus using any of a variety of bus architectures. As an illustration, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 1132, and all buses described herein may be implemented over a wired or wireless network connection and each of the subsystems, including the processor(s) 1114, the memory 1130 and memory elements therein, and the I/O interface(s) 1116 may be contained within one or more remote computing devices 1170 at physically separate locations, connected through buses of this form, in effect implementing a fully distributed system.

The computing device 1110 may comprise a variety of computer-readable media. Computer readable media may be any available media (transitory and non-transitory) that may be accessed by a computing device. In one aspect, computer-readable media may comprise computer non-transitory storage media (or computer-readable non-transitory storage media) and communications media. Example computer-readable non-transitory storage media may be any available media that may be accessed by the computing device 1110, and may comprise, for example, both volatile and non-volatile media, and removable and/or non-removable media. In one aspect, the memory 1130 may comprise computer-readable media in the form of volatile memory, such as random access memory (RAM), and/or non-volatile memory, such as read only memory (ROM).

The memory 1130 may comprise functionality instructions storage 1134 and functionality information storage 1138. The functionality instructions storage 1134 may comprise computer-accessible instructions that, in response to execution (by at least one of the processor(s) 1114), may implement one or more of the functionalities of the disclosure. The computer-accessible instructions may embody or may include one or more of the software components illustrated as narrowband association component(s) 1136. In one scenario, execution of at least one component of the narrowband association component(s) 1136 may implement one or more of the techniques disclosed herein. For instance, such execution may cause a processor that executes the at least one component to carry out a disclosed example method. It should be appreciated that, in one aspect, a processor of the processor(s) 1114 that executes at least one of the narrowband association component(s) 1136 may retrieve information from or retain information in a memory element 1140 in the functionality information storage 1138 in order to operate in accordance with the functionality programmed or otherwise configured by the narrowband association component(s) 1136. Such information may include at least one of code instructions, information structures, or the like. At least one of the one or more interfaces 1150 (e.g., application programming interface(s)) may permit or facilitate communication of information between two or more components within the functionality instructions storage 1134. The information that is communicated by the at least one interface may result from implementation of one or more operations in a method of the disclosure. In certain embodiments, one or more of the functionality instructions storage 1134 and the functionality information storage 1138 may be embodied in or may comprise removable/non-removable, and/or volatile/non-volatile computer storage media.

At least a portion of at least one of the narrowband association component(s) 1136 or narrowband association information 1140 may program or otherwise configure one or more of the processors 1114 to operate at least in accordance with the functionality described herein. One or more of the processor(s) 1114 may execute at least one of such components and leverage at least a portion of the information in the storage 1138 in order to provide association between communication devices in accordance with one or more aspects described herein. More specifically, yet not exclusively, execution of one or more of the component(s) 1136 may permit transmitting and/or receiving information at the computing device 1110, where the at least a portion of the information include one or more packets having preambles as described in connection with FIGS. 3-5, for example. As such, it should be appreciated that in certain embodiments, a combination of the processor(s) 1114, the narrowband association component(s) 1136, and the narrowband association information 1140 may form means for providing specific functionality for association between communication devices in accordance with one or more aspects of the disclosure.

It should be appreciated that, in certain scenarios, the functionality instruction(s) storage 1134 may embody or may comprise a computer-readable non-transitory storage medium having computer-accessible instructions that, in response to execution, cause at least one processor (e.g., one or more of processor(s) 1114) to perform a group of operations comprising the operations or blocks described in connection with the disclosed methods.

In addition, the memory 1130 may comprise computer-accessible instructions and information (e.g., data and/or metadata) that permit or facilitate operation and/or administration (e.g., upgrades, software installation, any other configuration, or the like) of the computing device 1110. Accordingly, as illustrated, the memory 1130 may comprise a memory element 1142 (labeled OS instruction(s) 1142) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architectural complexity of the computing device 1110 may dictate a suitable OS. The memory 1130 also comprises a system information storage 1146 having data and/or metadata that permits or facilitate operation and/or administration of the computing device 1110. Elements of the OS instruction(s) 1142 and the system information storage 1146 may be accessible or may be operated on by at least one of the processor(s) 1114.

It should be recognized that while the functionality instructions storage 1134 and other executable program components (such as the operating system instruction(s) 1142) are illustrated herein as discrete blocks, such software components may reside at various times in different memory components of the computing device 1110, and may be executed by at least one of the processor(s) 1114. In certain scenarios, an implementation of the narrowband association component(s) 1136 may be retained on or transmitted across some form of computer readable media.

The computing device 1110 and/or one of the computing device(s) 1170 may include a power supply (not shown), which may power up components or functional elements within such devices. The power supply may be a rechargeable power supply, e.g., a rechargeable battery, and it may include one or more transformers to achieve a power level suitable for operation of the computing device 1110 and/or one of the computing device(s) 1170, and components, functional elements, and related circuitry therein. In certain scenarios, the power supply may be attached to a conventional power grid to recharge and ensure that such devices may be operational. In one aspect, the power supply may include an I/O interface (e.g., one of the network adapter(s) 1118) to connect operationally to the conventional power grid. In another aspect, the power supply may include an energy conversion component, such as a solar panel, to provide additional or alternative power resources or autonomy for the computing device 1110 and/or one of the computing device(s) 1170.

The computing device 1110 may operate in a networked environment by utilizing connections to one or more remote computing devices 1170. As an illustration, a remote computing device may be a personal computer, a portable computer, a server, a router, a network computer, a peer device or other common network node, and so on. As described herein, connections (physical and/or logical) between the computing device 1110 and a computing device of the one or more remote computing devices 1170 may be made via one or more traffic and signaling pipes 1160, which may comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

It should be appreciated that portions of the computing device 1110 may embody or may constitute an apparatus. For instance, at least one of the processor(s) 1114, at least a portion of the radio unit 1112, and at least a portion of the memory 1130 may embody or may constitute an apparatus that may operate in accordance with one or more aspects of this disclosure.

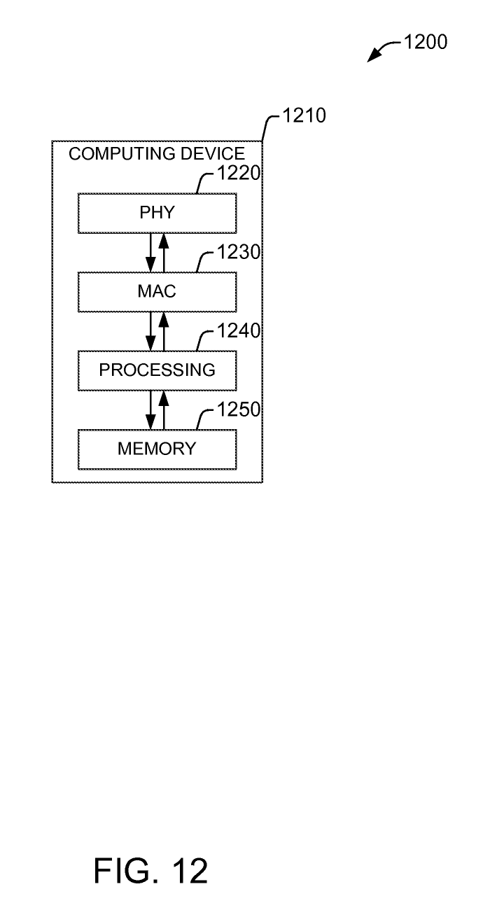

FIG. 12 presents another example embodiment 1200 of a computing device 1210 in accordance with one or more embodiments of the disclosure. In certain embodiments, the computing device 1210 may be a HEW-compliant device that may be configured to communicate with one or more other HEW devices and/or other type of communication devices, such as legacy communication devices. HEW devices and legacy devices also may be referred to as HEW stations (HEW STAs) and legacy STAs, respectively. In one implementation, the computing device 1210 may operate as an access point (such as AP 120). As illustrated, the computing device 1210 may include, among other things, physical layer (PHY) circuitry 1220 and medium-access-control layer (MAC) circuitry 1230. In one aspect, the PHY circuitry 1220 and the MAC circuitry 1230 may be HEW compliant layers and also may be compliant with one or more legacy IEEE 802.12 standards. In one aspect, the MAC circuitry 1230 may be arranged to configure physical layer converge protocol (PLCP) protocol data units (PPDUs) and arranged to transmit and receive PPDUs, among other things. In addition or in other embodiments, the computing device 1210 also may include other hardware processing circuitry 1240 (e.g., one or more processors) and one or more memory devices 1250 configured to perform the various operations described herein.

In certain embodiments, the MAC circuitry 1230 may be arranged to contend for a wireless medium during a contention period to receive control of the medium for the HEW control period and configure an HEW PPDU. In addition or in other embodiments, the PHY 1220 may be arranged to transmit the HEW PPDU. The PHY circuitry 1220 may include circuitry for modulation/demodulation, upconversion/downconversion, filtering, amplification, etc. As such, the computing device 1210 may include a transceiver to transmit and receive data such as HEW PPDU. In certain embodiments, the hardware processing circuitry 1240 may include one or more processors. The hardware processing circuitry 1240 may be configured to perform functions based on instructions being stored in a memory device (e.g., RAM or ROM) or based on special purpose circuitry. In certain embodiments, the hardware processing circuitry 1240 may be configured to perform one or more of the functions described herein, such as allocating bandwidth or receiving allocations of bandwidth.

In certain embodiments, one or more antennas (not depicted in FIG. 12) may be coupled to or included in the PHY circuitry 1220. The antenna(s) may transmit and receive wireless signals, including transmission of HEW packets. As described herein, the one or more antennas may include one or more directional or omnidirectional antennas, including dipole antennas, monopole antennas, patch antennas, loop antennas, microstrip antennas or other types of antennas suitable for transmission of RF signals. In scenarios in which MIMO communication is utilized, the antennas may be physically separated to leverage spatial diversity and the different channel characteristics that may result.

The memory 1250 may store information for configuring the other circuitry to perform operations for configuring and transmitting HEW packets or other types of radio packets, and performing the various operations described herein including the allocation and/or use of bandwidth (e.g., as it may be the case in an AP) and using the allocation of the bandwidth (e.g., as it may be the case in a STA).

The computing device 1210 may be configured to communicate using OFDM communication signals over a multicarrier communication channel. More specifically, in certain embodiments, the computing device 1210 may be configured to communicate in accordance with one or more specific radio technology protocols, such as the IEEE family of standards including IEEE 802.11a, 802.11n, 802.11ac, 802.11ax, DensiFi, and/or proposed specifications for WLANs. In one of such embodiments, the computing device 1210 may utilize or otherwise rely on symbols having a duration that is four times the symbol duration of 802.11n and/or 802.11ac. It should be appreciated that the disclosure is not limited in this respect and, in certain embodiments, the computing device 1210 also may transmit and/or receive wireless communications in accordance with other protocols and/or standards.

The computing device 1210 may be embodied in or may constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11 or IEEE 802.16, or other type of communication device that may receive and/or transmit information wirelessly. Similarly to the computing device 910, the computing device 1210 may include, for example, one or more of a keyboard, a display, a non-volatile memory port, multiple antennas, a graphics processor, an application processor, speakers, and other mobile device elements. The display may be an LCD screen including a touch screen.

It should be appreciated that while the computing device 1210 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In certain embodiments, the functional elements may refer to one or more processes operating or otherwise executing on one or more processors. It should further be appreciated that portions of the computing device 1210 may embody or may constitute an apparatus. For instance, the processing circuitry 1240 and the memory 1250 may embody or may constitute an apparatus that may operate in accordance with one or more aspects of this disclosure.

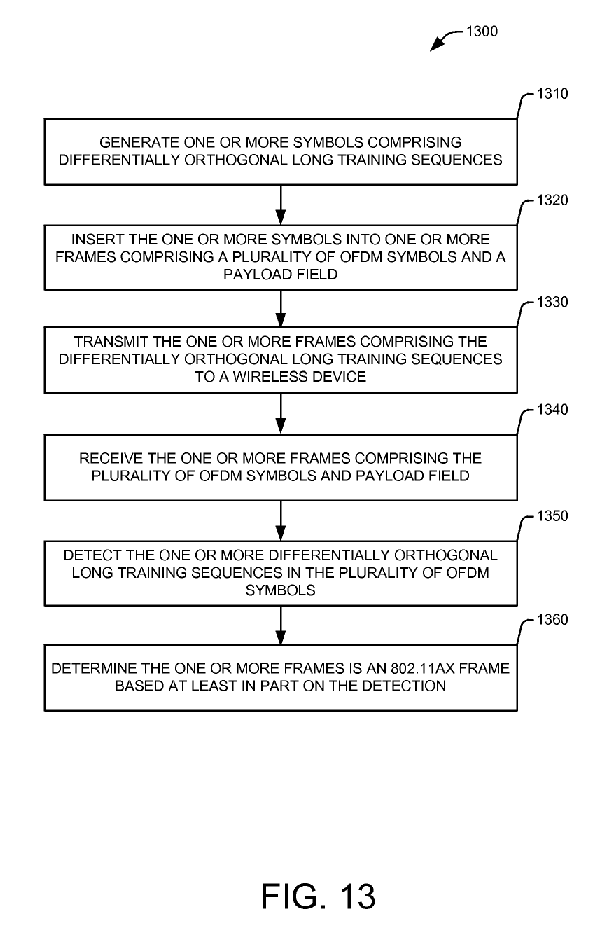

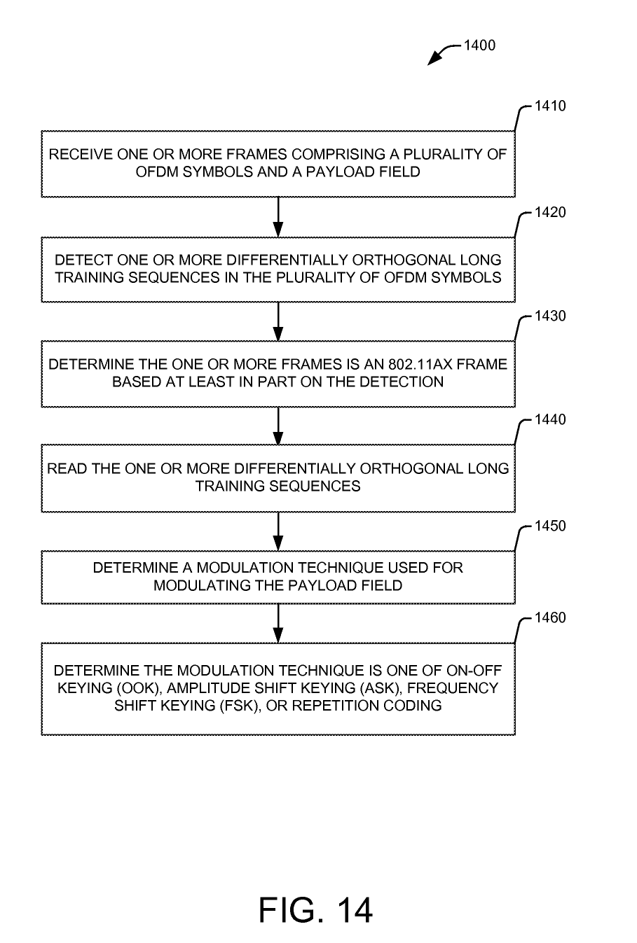

In view of the aspects described herein, various techniques for association requests between communication devices may be implemented in accordance with the disclosure. Examples of such techniques may be better appreciated with reference, for example, to the flowcharts in FIGS. 13-14. For purposes of simplicity of explanation, the example method disclosed herein is presented and described as a series of blocks (with each block representing an action or an operation in a method, for example). However, it is to be understood and appreciated that the disclosed method is not limited by the order of blocks and associated actions or operations, as some blocks may occur in different orders and/or concurrently with other blocks from those that are shown and described herein. For example, the various methods (or processes or techniques) in accordance with this disclosure may be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes may be implemented in combination with each other, to accomplish one or more features or advantages described herein.

It should be appreciated that the techniques of the disclosure may be retained on an article of manufacture, or computer-readable medium, to permit or facilitate transporting and transferring such methods to a computing device (e.g., a desktop computer; a mobile computer, such as a tablet, or a smartphone; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed techniques, may be employed to execute code instructions retained in a memory, or any computer- or machine-readable medium, to implement the one or more methods. The code instructions may provide a computer-executable or machine-executable framework to implement the techniques described herein.

FIGS. 13-14 present example methods 1300 and 1400 for classification of an 802.11ax frame or packet between a station or other type of user equipment and an access point in accordance with one or more embodiments of the disclosure. The station may implement at least some of the blocks of the example method 1300. At block 1310, the station may generate one or more symbols including differentially orthogonal long training sequences. At block 1320, the station may insert the one or more symbols into one or more frames including a plurality of OFDM symbols and a payload field. The one or more symbols including the differentially orthogonal long training sequences may be inserted, for example, following the legacy signal filed in the one or more frames. At block 1330, the station may transmit the one or more frames including the differentially orthogonal long training sequences to a wireless device, such as an access point. At block 1340, the access point may receive the one or more frames including the plurality of OFDM symbols and the payload field. At block 1350, the station may detect the one or more differentially orthogonal long training sequences in the plurality of OFDM symbols using, for example, a block differential detector. At block 1360, the station may determine the one or more frames is an 802.11ax frame or packet based at least in part on the detection.

It may be appreciated that the example method 1300 may represent the operational behavior of a station or other type of user equipment that attempts to associate with an access point in the presence of a link-budget imbalance as described herein. Example method 1400 may represent the behavior of the access point in response to the station or the other equipment attempting to associate with the access point. At block 1410, the AP may receive one or more frames comprising a plurality of OFDM symbols and a payload field. At 1420, the AP may detect one or more differentially orthogonal long training sequences in the plurality of OFDM symbols. At 1430, the AP may determine the one or more frames is an 802.11ax frame based at least in part on the detection. At block 1440, the AP may read the one or more differentially orthogonal long training sequences and determine a modulation technique used for modulating the payload field at block 1450. At block 1460, the AP may determine the modulation technique to be one of OOK, ASK, FSK, or eight times repetition coding. Although station and AP are used as examples in methods 1300 and 1400, respectively, the methods described in these example embodiments may be applicable to any wireless device. For example, the AP may implement the method in 1300 and station may implement the method in 1400 as applicable. In other words, the methods described in these example embodiments may be applicable to uplink or downlink data streams in any 802.11 wireless network environment.

Additional or alternative embodiments of the disclosure emerge from the foregoing description and the annexed drawings. In certain embodiments, the disclosure provides an apparatus for wireless telecommunication including at least one memory device having programmed instructions, and at least one processor functionally coupled to the at least one memory device and configured to execute the programmed instructions, and in response to execution of the programmed instructions, further configured to generate one or more symbols comprising differentially orthogonal long training sequences, insert the one or more symbols in one or more frames comprising a plurality of orthogonal frequency-division multiple access symbols and a payload field, and transmit the one or more frames to a wireless device. The payload field may be modulated according to one of on-off keying (OOK), amplitude shift keying (ASK), frequency shift keying (FSK), or repetition coding. The processor may be configured to modulate the frame using on-off keying, the payload field comprising a preamble, a medium access control (MAC) header, a content field, and a validation field, wherein the MAC header conveys that the frame corresponds to the request for the narrowband resource block, the content field conveys the identification code, and the validation field corresponds to a frame check sequence of the MAC header and the content field. The one or more symbols may indicate a low power packet. The one or more symbols comprising differentially orthogonal long training sequences are inserted following a legacy signal filed in the one or more frames. The differentially orthogonal long training sequences denote a single user environment, a multi-user environment, an indoor environment, or outdoor environment. The one or more frames may be a down-link or an up-link data frame or packet.

Another example embodiment may relate to a method for wireless communication including generating, by a communication device having at least one processor and at least one memory device, one or more symbols comprising differentially orthogonal long training sequences, inserting, by the communication device, the one or more symbols in one or more frames comprising a plurality of orthogonal frequency-division multiple access symbols and a payload field, and transmitting, by the communication device, the one or more frames to a wireless device. The payload field may be modulated according to one of on-off keying (OOK), amplitude shift keying (ASK), frequency shift keying (FSK), or repetition coding. Generating the frame may include modulating the frame using on-off keying, the payload field including a preamble, a medium access control (MAC) header, a content field, and a validation field, wherein the MAC header conveys that the frame corresponds to the request for the narrowband resource block, the content field conveys the identification code, and the validation field corresponds to a frame checksum of the MAC header and the content field. The one or more symbols may indicate a low power packet. The one or more symbols may include differentially orthogonal long training sequences are inserted following a legacy signal filed in the one or more frames. The differentially orthogonal long training sequences may denote a single user environment, a multi-user environment, an indoor environment, or outdoor environment. The one or more frames may be a down-link or an up-link data frame or packet.

Another example embodiment may relate to a wireless communication device including at least one memory device having programmed instructions, and at least one processor functionally coupled to the at least one memory device and configured to execute the programmed instructions, and in response to execution of the programmed instructions, further configured to receive one or more frames comprising a plurality of OFDM symbols and a payload field, detect one or more differentially orthogonal long training sequences in the plurality of OFDM symbols, determine the one or more frame is an 802.11ax frame based at least in part on the detection. The payload field may be modulated according to one of on-off keying (OOK), amplitude shift keying (ASK), frequency shift keying (FSK), or repetition coding. The processor may be further configured to read the one or more differentially orthogonal long training sequences, and determine a modulation technique used for modulating the payload field. The one or more differentially orthogonal long training sequences may indicate a low power packet. The one or more differentially orthogonal long training sequences may be detected following a legacy signal filed in the one or more frames. The differentially orthogonal long training sequences denote a single user environment, a multi-user environment, an indoor environment, or outdoor environment.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions may be read or otherwise accessed and executed by one or more processors to perform or permit performance of the operations described herein. The instructions may be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media may include read only memory (ROM); random access memory (RAM); magnetic disk storage media; optical storage media; flash memory, etc.

Embodiments of the operational environments and techniques (procedures, methods, processes, and the like) are described herein with reference to block diagrams and flowchart illustrations of methods, systems, apparatuses and computer program products. It may be understood that each block of the block diagrams and flowchart illustrations, and combinations of blocks in the block diagrams and flowchart illustrations, respectively, may be implemented by computer-accessible instructions. In certain implementations, the computer-accessible instructions may be loaded or otherwise incorporated onto a general purpose computer, special purpose computer, or other programmable information processing apparatus to produce a particular machine, such that the operations or functions specified in the flowchart block or blocks may be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “architecture,” “interface,” “unit,” “engine,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device may be a component. One or more components may reside within a process and/or thread of execution. A component may be localized on one computing device or distributed between two or more computing devices. As described herein, a component may execute from various computer-readable non-transitory media having various data structures stored thereon. Components may communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component may be an apparatus with specific functionality provided by mechanical parts operated by electric or electronic circuitry that is controlled by a software application or firmware application executed by a processor, wherein the processor may be internal or external to the apparatus and may execute at least a part of the software or firmware application. As yet another example, a component may be an apparatus that provides specific functionality through electronic components without mechanical parts, the electronic components may include a processor therein to execute software or firmware that confers at least in part the functionality of the electronic components. An interface may include input/output (I/O) components as well as associated processor, application, and/or other programming components. The terms “component,” “environment,” “system,” “architecture,” “interface,” “unit,” “engine,” “module” may be utilized interchangeably and may be referred to collectively as functional elements.

In the present specification and annexed drawings, reference to a “processor” is made. As utilized herein, a processor may refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor may refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor may be implemented as a combination of computing processing units. In certain embodiments, processors may utilize nanoscale architectures such as, but not limited to, molecular and quantum-dot based transistors, switches and gates, in order to optimize space usage or enhance performance of user equipment.

In addition, in the present specification and annexed drawings, terms such as “store,” “storage,” “data store,” “data storage,” “memory,” “repository,” and substantially any other information storage component relevant to operation and functionality of a component of the disclosure, refer to “memory components,” entities embodied in a “memory,” or components forming the memory. It may be appreciated that the memory components or memories described herein embody or comprise non-transitory computer storage media that may be readable or otherwise accessible by a computing device. Such media may be implemented in any methods or technology for storage of information such as computer-readable instructions, information structures, program modules, or other information objects. The memory components or memories may be either volatile memory or non-volatile memory, or may include both volatile and non-volatile memory. In addition, the memory components or memories may be removable or non-removable, and/or internal or external to a computing device or component. Example of various types of non-transitory storage media may comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which may be accessed by a computing device.

As an illustration, non-volatile memory may include read only memory (ROM), programmable ROM (PROM), electrically programmable ROM (EPROM), electrically erasable ROM (EEPROM), or flash memory. Volatile memory may include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that may permit association between communication devices (e.g., a station and an access point) in the presence of a link-budget imbalance between such devices. It is, of course, not possible to describe every conceivable combination of elements and/or methods for purposes of describing the various features of the disclosure, but it may be recognized that many further combinations and permutations of the disclosed features are possible. Accordingly, it may be apparent that various modifications may be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. An apparatus for wireless communication, comprising:
at least one memory device having programmed instructions; and
at least one processor functionally coupled to the at least one memory device and configured to execute the programmed instructions, and in response to execution of the programmed instructions, further configured to:
generate one or more symbols comprising differentially orthogonal long training sequences;
generate one or more frames comprising the one or more symbols, a plurality of orthogonal frequency-division multiple access symbols, and a payload field; and
cause to transmit the one or more frames to a wireless device.

2. The apparatus of claim 1, wherein the payload field is modulated according to one of on-off keying (OOK), amplitude shift keying (ASK), frequency shift keying (FSK), or repetition coding.

3. The apparatus of claim 1, wherein the at least one processor is further configured to modulate the frame using on-off keying, the payload field comprising a preamble, a medium access control (MAC) header, a content field, and a validation field,
wherein the MAC header conveys that the frame corresponds to a request for the narrowband resource block, the content field conveys the identification code, and the validation field corresponds to a frame check sequence of the MAC header and the content field.

4. The apparatus of claim 1, wherein the one or more symbols indicate a low power packet.

5. The apparatus of claim 1, wherein the one or more symbols comprising differentially orthogonal long training sequences are inserted following a legacy signal filed in the one or more frames.

6. The apparatus of claim 1, wherein the differentially orthogonal long training sequences indicate a single user environment, a multi-user environment, an indoor environment, or outdoor environment.

7. The apparatus of claim 1, further comprising:
at least one radio; and
one or more antennas.

8. A non-transitory computer-readable medium comprising computer-executable instructions that when executed by a processor cause the processor to:
identify that one or more frames comprising a plurality of OFDM symbols and a payload field received from a wireless device;
detect one or more differentially orthogonal long training sequences in the plurality of OFDM symbols; and
determine that the one or more frame is an 802.11ax frame based at least in part on the detection.

9. The medium of claim 8, wherein the payload field is modulated according to one of on-off keying (OOK), amplitude shift keying (ASK), frequency shift keying (FSK), or repetition coding.

10. The medium of claim 8, wherein the at least one processor is further configured to:
read the one or more differentially orthogonal long training sequences; and
determine a modulation technique used for modulating the payload field.

11. The medium of claim 8, wherein the one or more differentially orthogonal long training sequences indicate a low power packet.

12. The medium of claim 8, wherein the one or more differentially orthogonal long training sequences are detected following a legacy signal filed in the one or more frames.

13. The medium of claim 8, wherein the differentially orthogonal long training sequences indicate a single user environment, a multi-user environment, an indoor environment, or outdoor environment.

14. A method, comprising:
generating, by a wireless device comprising at least one processor, one or more symbols comprising differentially orthogonal long training sequences;
generating, by the wireless device, one or more frames comprising the one or more symbols, a plurality of orthogonal frequency-division multiple access symbols, and a payload field; and
cause to transmit, by the wireless device, the one or more frames to a second wireless device.

15. The method of claim 14, wherein the payload field is modulated according to one of on-off keying (OOK), amplitude shift keying (ASK), frequency shift keying (FSK), or repetition coding.

16. The method of claim 14, wherein generating the frame comprises modulating the frame using on-off keying, the payload field including a preamble, a medium access control (MAC) header, a content field, and a validation field,
wherein the MAC header conveys that the frame corresponds to a request for the narrowband resource block, the content field conveys the identification code, and the validation field corresponds to a frame checksum of the MAC header and the content field.

17. The method of claim 14, wherein the one or more symbols indicate a low power packet.

18. The method of claim 14, wherein the one or more symbols comprising differentially orthogonal long training sequences are inserted following a legacy signal filed in the one or more frames.

19. The method of claim 14, wherein the differentially orthogonal long training sequences indicate a single user environment, a multi-user environment, an indoor environment, or outdoor environment.

20. The method of claim 14, wherein the one or more frames is a down-link or an up-link data frame or packet.
